(19) United States
(12) Patent Application Publication
(10) Pub. No.: US 2025/0336341 A1
(43) Pub. Date: Oct. 30, 2025

(54) ELECTRONIC DEVICE AND METHOD OF OPERATING THE ELECTRONIC DEVICE

(71) Applicant: SAMSUNG ELECTRONICS CO., LTD., Suwon-si (KR)

(72) Inventors: Kiwoo KIM, Suwon-si (KR); Seungwon SEOK, Suwon-si (KR); Changmin KEUM, Suwon-si (KR)

(73) Assignee: SAMSUNG ELECTRONICS CO., LTD., Suwon-si (KR)

(21) Appl. No.: 19/219,123

(22) Filed: May 27, 2025

Related U.S. Application Data
(63) Continuation of application No. PCT/KR2025/005499, filed on Apr. 23, 2025.

(30) Foreign Application Priority Data
Apr. 30, 2024 (KR) 10-2024-0058138
Jan. 15, 2025 (KR) 10-2025-0006391

(51) Int. Cl. G09G 3/32

(52) U.S. Cl. CPC G09G 3/32; G09G 2300/0426; G09G 2300/0819; G09G 2300/0842; G09G 2310/08; G09G 2320/0233

(57) ABSTRACT

An electronic device includes a display including a pixel that includes a light emitting diode, a first transistor having first and second electrodes and first and second control electrodes, the first electrode being electrically connected to a first voltage line that provides a first driving voltage and the second electrode being electrically connected to an anode of the light emitting diode, a second transistor electrically connected between the first control electrode of the first transistor and the second electrode of the first transistor, and a third transistor electrically connected between the second control electrode of the first transistor and a data line that provides a data signal. A control electrode of the second transistor and a control electrode of the third transistor are electrically connected to a scan line that provides a same scan signal.

### CROSS-REFERENCE TO RELATED APPLICATIONS

This application is a continuation application based on International Patent Application No. PCT/KR2025/005499 filed on Apr. 23, 2025 in the Korean Intellectual Property Office, which is based on and claims priority under 35 U.S.C. § 119 to Korean Patent Application No. 10-2024-0058138 filed on Apr. 30, 2024, and to Korean Patent Application No. 10-2025-0006391 filed on Jan. 15, 2025, in the Korean Intellectual Property Office, the disclosure of each of these three applications being incorporated by reference herein in their entireties.

### BACKGROUND

### 1. Field

The disclosure relates to an electronic device and a method of operating the electronic device and, more specifically, to an electronic device including a display having a plurality of pixels and a method of operating the electronic device.

### 2. Description of Related Art

With the advancement of electronic technologies, various types of electronic devices are being developed and released. Electronic devices including a display for displaying images have undergone rapid development in recent years.

Along with technological developments, various types, layouts, number, etc., of circuit devices for controlling operation of a plurality of pixels included in the display are also being developed.

Furthermore, a circuit structure for operating the pixels at high speed are being developed through the development of high-resolution, high-frequency images, etc.

Moreover, a circuit structure is being developed to compensate for phenomena such as a non-uniformity of transistor characteristics due to display process deviations, a voltage drop caused by a current flowing in a wire, etc.

### SUMMARY

In accordance with an aspect of the disclosure, an electronic device includes a display including a plurality of pixels; a memory storing a program or at least one instruction; and at least one processor. The at least one processor is configured to individually or collectively execute the program or the at least one instruction stored in the memory to cause the electronic device to control the display to display an image. One pixel of the plurality of pixels comprises a light emitting diode; a first transistor having a first electrode, a first control electrode, a second control electrode, and a second electrode, the first electrode being electrically connected to a first voltage line that provides a first driving voltage and the second electrode being electrically connected to an anode of the light emitting diode; a second transistor having a control electrode, the second transistor being electrically connected between the first control electrode of the first transistor and the second electrode of the first transistor; and a third transistor having a control electrode, the third transistor being electrically connected between the second control electrode of the first transistor and a data line that provides a data signal. The control electrode of the second transistor and the control electrode of the third transistor are electrically connected to a scan line that provides a same scan signal.

In accordance with an aspect of the disclosure, a method of operating an electronic device includes displaying an image through a display including a plurality of pixels. One pixel of the plurality of pixels comprises a light emitting diode; a first transistor having a first electrode, a first control electrode, a second control electrode, and a second electrode, the first transistor being electrically connected to a first voltage line that provides a first driving voltage and a second electrode electrically connected to an anode of the light emitting diode; a second transistor having a control electrode, the second transistor being electrically connected between the first control electrode of the first transistor and the second electrode of the first transistor; and a third transistor having a control electrode, the third transistor being electrically connected between the second control electrode of the first transistor and a data line that provides a data signal. The control electrode of the second transistor and the control electrode of the third transistor are electrically connected to a scan line that provides a same scan signal.

In accordance with an aspect of the disclosure, a computer-readable recording medium having recorded thereon a program which, when executed by a computer, causes the computer to display an image through a display including a plurality of pixels. One pixel of the plurality of pixels comprises a light emitting diode; a first transistor having a first electrode, a first control electrode, a second control electrode, and a second electrode, the first transistor being electrically connected to a first voltage line that provides a first driving voltage and a second electrode electrically connected to an anode of the light emitting diode; a second transistor having a control electrode, the second transistor being electrically connected between the first control electrode of the first transistor and the second electrode of the first transistor; and a third transistor having a control electrode, the third transistor being electrically connected between the second control electrode of the first transistor and a data line that provides a data signal. The control electrode of the second transistor and the control electrode of the third transistor are electrically connected to a scan line that provides a same scan signal.

Additional aspects will be set forth in part in the description which follows and, in part, will be apparent from the description, or may be learned by practice of the presented embodiments.

### DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for describing an operation of an electronic device, according to an embodiment;

FIG. 2 is a block diagram of an electronic device according to an embodiment;

FIG. 3 is an equivalent circuit diagram of a pixel according to an embodiment;

FIG. 4 is an equivalent circuit diagram of a pixel according to an embodiment;

FIG. 5 is a flowchart for describing a method of operating an electronic device to operate a pixel, according to an embodiment;

FIG. 6 is a timing diagram of driving signals to operate a pixel, according to an embodiment;

FIG. 7 is a cross-sectional view of a display for describing a structure of a first transistor, according to an embodiment;

FIG. 8 is an equivalent circuit diagram of a pixel according to an embodiment;

FIG. 9 is an equivalent circuit diagram of a pixel according to an embodiment;

FIG. 10 is an equivalent circuit diagram of a pixel according to an embodiment;

FIG. 11 is a diagram for describing a layout of pixels according to an embodiment;

FIG. 12 is an enlarged diagram for describing a layout of a pixel according to an embodiment; and

FIG. 13 is a block diagram for describing a configuration of an electronic device according to an embodiment.

### DETAILED DESCRIPTION

The terms used in the specification will be briefly defined, and various embodiments will be described in detail.

Throughout the specification, the expression “or” is inclusive rather than exclusive, unless specifically mentioned otherwise. Hence, unless the context clearly indicates otherwise, “A or B” may refer to “A”, “B” or both.

Throughout the disclosure, the expression of the form “at least one of a, b or c” includes within its scope only a, only b, only c, both a and b, both a and c, both b and c, all of a, b, and c, or variations thereof.

The terms are selected as common terms that are currently widely used, taking into account principles of the disclosure, which may however depend on intentions of those of ordinary skill in the art, judicial precedents, emergence of new technologies, and the like. Some terms as used herein are selected at the applicant's discretion, in which case, the terms will be explained later in detail in connection with various embodiments. Therefore, the terms should be defined based on their meanings and descriptions throughout the disclosure.

As used herein, the singular forms “a”, “an” and “the” are intended to include the plural forms as well, unless the context clearly indicates otherwise. All terms including technical and scientific terms used herein have the same meaning as commonly understood by one of ordinary skill in the art to which this disclosure belongs.

The term “include (or including)” or “comprise (or comprising)” is inclusive or open-ended and does not exclude additional, unrecited elements or method steps. The terms “ . . . unit”, “module”, “block”, etc., as used herein each represent a unit for handling at least one function or operation, and may be implemented in hardware, software, or a combination thereof.

In the disclosure, the expression “configured to” as herein used may be interchangeably used with “suitable for”, “having the capacity to”, “designed to”, “adapted to”, “made to”, or “capable of” according to the given situation. The expression “configured to” may not necessarily mean “specifically designed to” in terms of hardware. For example, in some situations, an expression “a system configured to do something” may refer to “an entity able to do something in cooperation with” another device or parts. For example, “a processor configured to perform A, B and C functions” may refer to a dedicated processor, e.g., an embedded processor for performing A, B and C functions, or a general-purpose processor, e.g., a Central Processing Unit (CPU) or an application processor that may perform A, B and C functions by executing one or more software programs stored in a memory.

When the term “connected” or “coupled” is used, a component may be directly connected or coupled to another component. However, unless otherwise defined, it is also understood that the component may be indirectly connected or coupled to the other component via another new component.

It is to be understood that blocks of each flowchart and combinations of flowcharts may be performed by one or more computer programs including computer-executable instructions. The one or more computer programs may be stored all in a single memory or may be distributed in many different memories.

All functions or operations as described in the specification may be processed by a single processor or a combination of a plurality of processors.

Various embodiments will now be described in detail with reference to accompanying drawings so as to be readily practiced by those of ordinary skill in the art. However, various embodiments may be implemented in many different forms, and embodiments are not limited to those discussed herein. In the drawings, parts unrelated to the description are omitted for clarity, and like numerals refer to like elements throughout the specification.

Various embodiments will now be described in detail with reference to accompanying drawings.

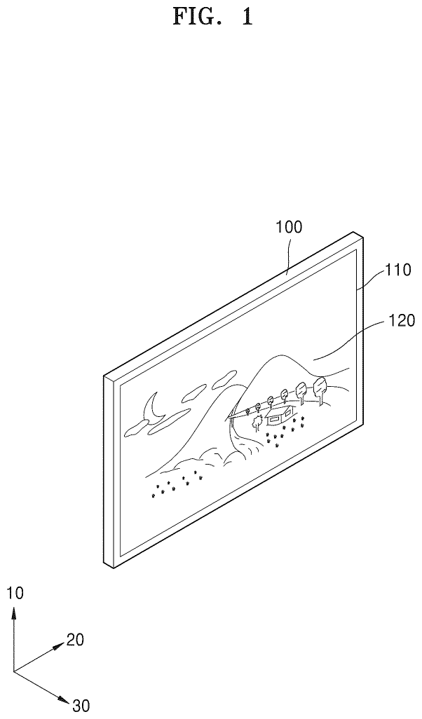

FIG. 1 is a diagram for describing an operation of an electronic device, according to an embodiment.

Referring to FIG. 1, in an embodiment, shown is an electronic device 100. The electronic device 100 may include a display 110 on which an image 120 is displayed.

In an embodiment, through the display 110 parallel to a first direction 10 and a second direction 20, the electronic device 100 may display the image 120 in a third direction 30. The direction in which the image 120 is displayed may correspond to a front surface of the electronic device 100.

Although the electronic device 100 is shown in FIG. 1 as a rigid type of electronic device in a bar shape, embodiments are not limited thereto. In an embodiment, the electronic device 100 may be a foldable, rollable or slidable type of electronic device. In this case, the display 110 may also have a bending or folding form with respect to a plane defined by the first direction 10 and the second direction 20.

A normal direction substantially perpendicular to the plane defined by the first direction 10 and the second direction 20 is defined as the third direction 30. Throughout the specification, the expression “when viewed on a plane” may mean a state viewed from the third direction 30. In other words, the plane may be parallel to a plane defined by the first direction 10 and the second direction 20.

In an embodiment, the electronic device 100 may be implemented as various types of electronic devices such as a smart phone, a notebook computer, a tablet PC, a television, a wearable device, a head mounted display device, a digital signage, a personal computer (PC), etc.

In an embodiment, the display 110 may include a plurality of pixels. The electronic device 100 may control operation of each of the plurality of pixels included in the display 110 to display the image 120.

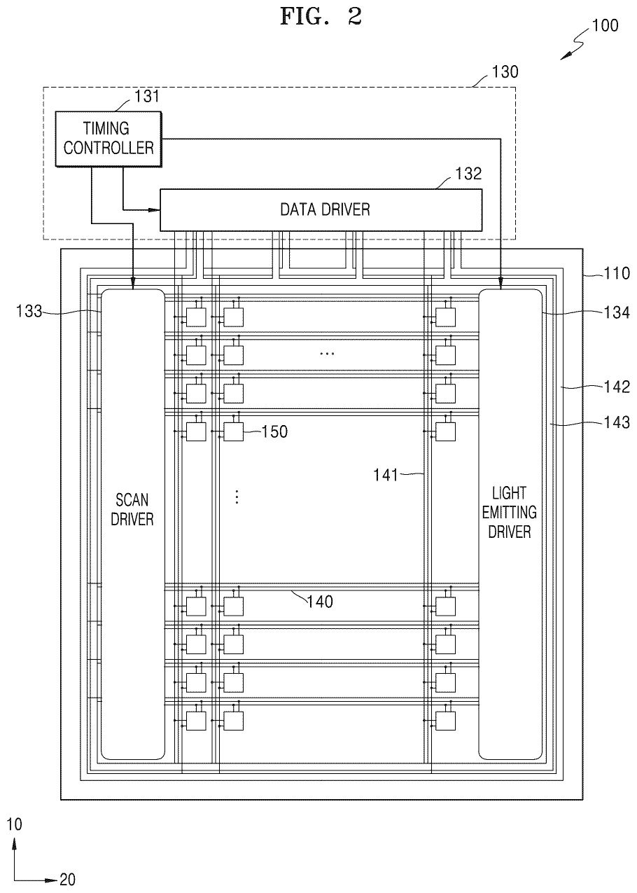

A structure of each of the plurality of pixels included in the display 110 and a method of operating each of the plurality of pixels to display the image 120 will now be described with reference to FIGS. 2 to 13.

FIG. 2 is a block diagram of an electronic device, according to an embodiment.

Referring to FIGS. 1 and 2, in an embodiment, the electronic device 100 may include the display 110 and at least one processor 130 as shown in FIG. 2.

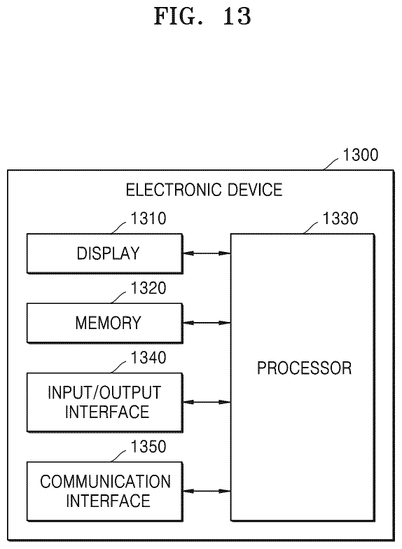

In an embodiment, the at least one processor 130 may include a timing controller 131 and a data driver 132. In an embodiment, the at least one processor 130 included in the electronic device 100 will be described later in connection with FIG. 13.

In an embodiment, the display 110 may include a scan driver 133, a light emitting driver 134, a plurality of scan lines 140, a plurality of data lines 141, a plurality of first voltage lines 142, a plurality of second voltage lines 143 and a plurality of pixels 150. Embodiments are not, however, limited thereto, and in some embodiments, the display 110 may further include a plurality of light emitting lines, a plurality of initialization scan lines, and a plurality of initialization lines.

In an embodiment, the timing controller 131 may obtain an image signal and a scan control signal from outside the electronic device 100. The timing controller 131 may provide the data driver 132 with an output image signal obtained by converting a data format of the image signal to be suitable to the data driver 132 and the display 110.

In an embodiment, the data driver 132 may convert the output image signal to a plurality of data signals, and provide the plurality of data signals to the plurality of data lines 141, respectively. The plurality of data signals may be analog voltages converted to correspond to a gray level of the output image signal.

In an embodiment, the display 110 may include a display area where the image 120 is displayed, and a non-display area (e.g., a bezel area) where no image is displayed. In an embodiment, the scan driver 133 and the light emitting driver 134 may be arranged in the non-display area.

In an embodiment, the scan control signal may include a first vertical initiation signal to initiate operation of the scan driver 133, a second vertical initiation signal to initiate operation of the light emitting driver 134, a clock signal to determine output timing of a plurality of signals, etc.

In an embodiment, the scan driver 133 may generate a plurality of scan signals based on the scan control signal. The scan driver 133 may provide the plurality of scan signals to the plurality of scan lines 140, respectively.

In an embodiment, the light emitting driver 134 may generate a plurality of light emitting signals based on the scan control signal. The light emitting driver 134 may provide the plurality of light emitting signals to the plurality of light emitting lines, respectively.

In an embodiment, the scan driver 133 and the light emitting driver 134 are shown as separate components in FIG. 2. Embodiments are not, however, limited thereto, and in some embodiments, the scan driver and the light emitting driver may be included in a same component. In this case, the component including the scan driver and the light emitting driver may be a single unit or two or more units, and arranged in the non-display area.

In an embodiment, in FIG. 2, the scan driver 133 is arranged on the left side of the non-display area and the light emitting driver 134 is arranged on the right side of the non-display area, without being limited thereto. In some embodiments, the light emitting driver 134 may be arranged on the left side of the non-display area and the scan driver 133 may be arranged on the right side of the non-display area, and where to arrange the light emitting driver 134 and the scan driver 133 is not limited in the non-display area.

In an embodiment, the plurality of scan lines 140 may extend from the scan driver 133 in the second direction 20, and may be arranged to be spaced from each other in the first direction 10 that crosses the second direction 20. The plurality of light emitting lines may extend from the light emitting driver 134 in the opposite direction of the second direction 20 and may be arranged to be spaced from each other in the first direction 10.

In an embodiment, the plurality of data lines 141 may extend from the data driver 132 in the opposite direction of the first direction 10, and may be arranged to be spaced from each other in the second direction 20. The plurality of data lines 141 may be arranged to be insulated from the plurality of scan lines 140 and the plurality of light emitting lines.

In an embodiment, each of the plurality of pixels 150 may be electrically connected to corresponding ones of the plurality of scan lines 140, the plurality of light emitting lines and the plurality of data lines 141. In an embodiment, depending on the configuration of the driving circuit included in each of the plurality of pixels 150, relationships between each of the plurality of pixels 150 and the plurality of scan lines 140, the plurality of light emitting lines and the plurality of data lines 141 may be changed.

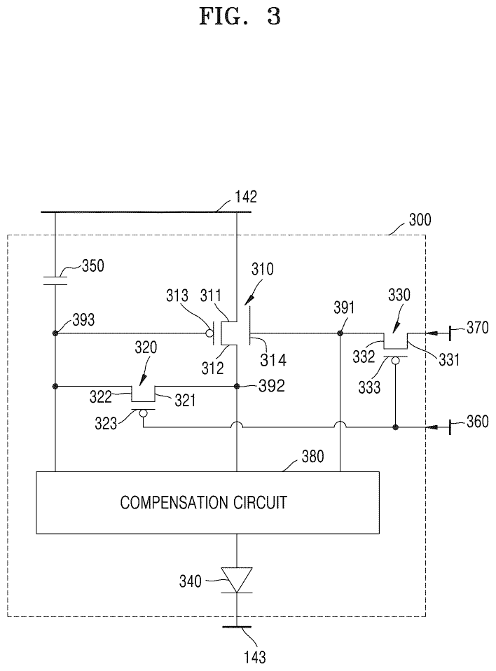

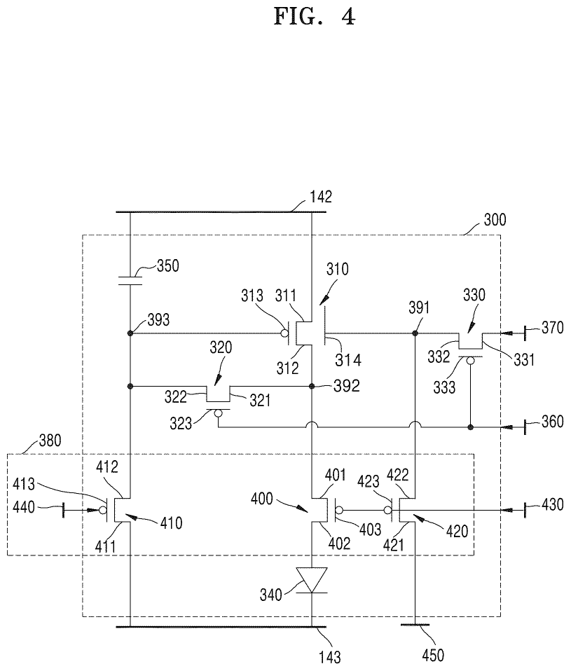

The driving circuit included in each of the plurality of pixels 150 will be described with reference to FIGS. 3 and 4.

In an embodiment, the electronic device 100 may further include a voltage generator. In an embodiment, the voltage generator may generate a plurality of voltages used for operations of the display 110. In an embodiment, the voltage generator may generate a first driving voltage, a second driving voltage and an initialization voltage. In an embodiment, the first driving voltage may include a power voltage ELVDD. The second driving voltage may include a common voltage ELVSS. The first driving voltage may be a higher level of voltage than the second driving voltage. In an embodiment, the initialization voltage may have a level lower than the first driving voltage and higher than the second driving voltage.

In an embodiment, each of the plurality of pixels 150 may receive the first driving voltage, the second driving voltage and the initialization voltage through the voltage generator. Each of the plurality of pixels 150 may be electrically connected to corresponding ones of the plurality of first voltage lines 142, the plurality of second voltage lines 143 and the plurality of initialization lines. Each pixel may receive the first driving voltage, the second driving voltage and the initialization voltage through the electrically connected first voltage line, second voltage line and initialization line.

In an embodiment, each of the plurality of pixels 150 may include at least one transistor, at least one capacitor and a light emitting diode. The at least one transistor and the at least one capacitor included in each of the plurality of pixels 150 may be referred to as a pixel driving circuit. In other words, in an embodiment, each of the plurality of pixels 150 may include a light emitting diode and a pixel driving circuit that drives the light emitting diode. The data driver 132, the scan driver 133 and the light emitting driver 134 may include a plurality of transistors formed through the same process as for the pixel driving circuit.

In an embodiment, the electronic device 100 may display the image 120 through the display 110 by controlling timings to apply each of the scan signal, data signal and light emitting signal to each of the plurality of pixels 150 and adjusting a length or a size of a signal section included in each signal.

FIG. 3 is an equivalent circuit diagram of a pixel, according to an embodiment. FIG. 3 illustrates a pixel 300 and, in an embodiment, the pixel 300 may correspond to one of the pixels 150 described above with reference to FIGS. 1 and 2.

Referring to FIGS. 2 and 3, in an embodiment, each of the plurality of pixels 150 included in the display 110 may include a plurality of sub-pixels including light emitting diodes that produce different color rays. In this case, the light emitting diode may refer to a light emitting device including a light emitting diode.

In an embodiment, each of the plurality of pixels 150 may include a red sub-pixel including a red light emitting diode that produces red light, a green sub-pixel including a green light emitting diode that produces green light, and a blue sub-pixel including a blue light emitting diode that produces blue light.

Embodiments are not, however, limited thereto, and in some embodiments, each of the plurality of pixels 150 may include at least one sub-pixel including light emitting diodes that produce various combinations of color rays to display the image 120.

In an embodiment, the pixel 300 of the plurality of pixels included in the display 110 is shown in FIG. 3. The pixel 300 shown in FIG. 3 may be one of the plurality of sub-pixels included in each of the plurality of pixels.

In an embodiment, the pixel 300 may include a first transistor 310, a second transistor 320, a third transistor 330, a light emitting diode 340, a capacitor 350 and a compensation circuit 380.

In an embodiment, the first transistor 310, the second transistor 320 and the third transistor 330 are described as P-type transistors.

Embodiments are not, however, limited thereto, and in some embodiments, at least one of the first transistor 310, the second transistor 320 or the third transistor 330 may be an N-type transistor.

In an embodiment, the first transistor 310 may be connected between the first voltage line 142 and the light emitting diode 340. In an embodiment, the first transistor 310 may have a first electrode 311, a second electrode 312, a first control electrode 313, and a second control electrode 314. The first electrode 311 of the first transistor 310 may be electrically connected to the first voltage line 142, and the second electrode 312 of the first transistor 310 may be electrically connected to the anode of the light emitting diode 340.

In an embodiment, the first electrode 311 of the first transistor 310 may refer to a source electrode. The second electrode 312 of the first transistor 310 may refer to a drain electrode. The first voltage line 142 may provide the first driving voltage to the first transistor 310.

Throughout the specification, the expression “electrically connected between the transistor and the signal line or between transistors” refers to the electrode of the transistor having a form integrated with the signal line or being connected to the signal line through a connection electrode. Furthermore, it will be understood that another transistor may be additionally arranged or omitted between the transistor and the signal line or between transistors.

In an embodiment, another transistor or a circuit element may be further arranged between the first electrode 311 of the first transistor 310 and the first voltage line 142. In an embodiment, another transistor or a circuit element may be further arranged between the second electrode 312 of the first transistor 310 and the anode of the light emitting diode 340. In an embodiment, the compensation circuit 380 may be further arranged between the first transistor 310 and the light emitting diode 340.

In an embodiment, the second transistor 320 may be connected between the first control electrode 313 of the first transistor 310 and the second electrode 312 of the first transistor 310. In an embodiment, the second transistor 320 may have a first electrode 321, a second electrode 322, and a control electrode 323. The first electrode 321 of the second transistor 320 may be electrically connected to the second electrode 312 of the first transistor 310, and the second electrode 322 of the second transistor 320 may be electrically connected to the first control electrode 313 of the first transistor 310.

In an embodiment, the first electrode 321 of the second transistor 320 and the second electrode 312 of the first transistor 310 may be connected through a second reference node 392. The second electrode 322 of the second transistor 320 and the first control electrode 313 of the first transistor 310 may be connected through a third reference node 393.

In an embodiment, the first control electrode 313 of the first transistor 310 may refer to a first gate electrode.

In an embodiment, the control electrode 323 of the second transistor 320 may be electrically connected to the scan line 360 that provides a scan signal. The second transistor 320 may obtain the scan signal through the scan line 360.

In an embodiment, the first electrode 321 of the second transistor 320 may refer to a source electrode, and the second electrode 322 of the second transistor 320 may refer to a drain electrode. The control electrode 323 of the second transistor 320 may refer to a gate electrode.

In an embodiment, the third transistor 330 may be connected between the second control electrode 314 of the first transistor 310 and a data line 370. In an embodiment, the third transistor 330 may have a first electrode 331, a second electrode 332, and a control electrode 333. The first electrode 331 of the third transistor 330 may be electrically connected to the data line 370, and a second electrode 332 of the third transistor 330 may be electrically connected to the second control electrode 314 of the first transistor 310. The second electrode 332 of the third transistor 330 and the second control electrode 314 of the first transistor 310 may be connected through a first reference node 391.

In an embodiment, the second control electrode 314 of the first transistor 310 may refer to a second gate electrode.

In an embodiment, the pixel 300 may further include a driving capacitor connected between the first voltage line 142 and the first reference node 391. In an embodiment, a first electrode of the driving capacitor may be electrically connected to the first voltage line 142, and a second electrode of the driving capacitor may be electrically connected to the first reference node 391.

In an embodiment, the driving capacitor may be formed by a portion of the second control electrode 314 of the first transistor 310 overlapping the first voltage line 142. In an embodiment, the driving capacitor may include a portion of the first voltage line 142 that overlaps the second control electrode 314 of the first transistor 310 as a first electrode of the driving capacitor, and a portion of the second control electrode 314 of the first transistor 310 that overlaps the first voltage line as a second electrode of the driving capacitor.

In an embodiment, the control electrode 333 of the third transistor 330 may be electrically connected to the scan line 360 that provides a scan signal. The third transistor 330 may obtain the scan signal through the scan line 360. The third transistor 330 may obtain a data signal through the data line 370.

In an embodiment, the control electrode 323 of the second transistor 320 and the control electrode 333 of the third transistor 330 may be electrically connected to the scan line 360 that provides the same scan signal.

In an embodiment, the first electrode 331 of the third transistor 330 may refer to a source electrode, and the second electrode 332 may refer to a drain electrode. The control electrode 333 of the third transistor 330 may refer to a gate electrode.

In an embodiment, the capacitor 350 may have a first electrode and a second electrode, and may be connected between the first voltage line 142 and the third reference node 393. In an embodiment, the first electrode of the capacitor 350 may be electrically connected to a voltage line 142, and the second electrode of the capacitor 350 may be electrically connected to the third reference node 393.

In an embodiment, the light emitting diode 340 may have an anode and a cathode, and may be connected between the first transistor 310 and the second voltage line 143. The anode of the light emitting diode 340 may be electrically connected to the second electrode 312 of the first transistor 310, and the cathode of the light emitting diode 340 may be electrically connected to the second voltage line 143.

In an embodiment, a driving current Ids determined based on voltages applied to the respective first control electrode 313, second control electrode 314 and first electrode 310 of the first transistor 310 is applied to the light emitting diode 340, so the driving current Ids may flow in the light emitting diode 340. This configuration makes the light emitting diode 340 generate light, and accordingly, the electronic device 100 may display the image 120.

In an embodiment, the light emitting diode 340 may include an organic light emitting diode or an inorganic light emitting diode, and is not limited to one of them.

In an embodiment, the first reference node 391, the second reference node 392, the third reference node 393 and the light emitting diode 340 may be electrically connected to the compensation circuit 380. In an embodiment, the compensation circuit 380 may include circuit components used to drive the pixel 300 to display the image 120.

In an embodiment, the compensation circuit 380 may include at least one transistor. The number, type, layout, connection relationship of the at least one transistor included in the compensation circuit 380 may vary depending on the operation method of the display 110 or the type of the light emitting diode 340. Embodiments are not limited thereto, and in some embodiments, the compensation circuit 380 may further include other circuit elements (e.g., capacitors, etc.).

A circuit configuration, layout or connection relationship of the compensation circuit 380 will now be described in connection with FIG. 4.

FIG. 4 is an equivalent circuit diagram of a pixel, according to an embodiment. The same components as described in FIG. 3 will now be given the same reference numerals, and the description thereof will be omitted for conciseness.

Referring to FIGS. 3 and 4, in an embodiment, the pixel 300 may include the first transistor 310, the second transistor 320, the third transistor 330, the light emitting diode 340, the capacitor 350 and the compensation circuit 380.

In an embodiment, the compensation circuit 380 may include a fourth transistor 400, a fifth transistor 410 and a sixth transistor 420.

In an embodiment, the fourth transistor 400 may have a first electrode 401, a second electrode 402, and a control electrode 403, and may be connected between the anode of the light emitting diode 340 and the second electrode 312 of the first transistor 310. The first electrode 401 of the fourth transistor 400 may be electrically connected to the second electrode 312 of the first transistor 310, and the second electrode 402 of the fourth transistor 400 may be electrically connected to the anode of the light emitting diode 340.

In an embodiment, the first electrode 401 of the fourth transistor 400 and the second electrode 312 of the first transistor 310 may be connected through the second reference node 392.

In an embodiment, the control electrode 403 of the fourth transistor 400 may be electrically connected to the light emitting line 430. The fourth transistor 400 may obtain a light emitting signal through the light emitting line 430.

In an embodiment, the first electrode 401 of the fourth transistor 400 may refer to a source electrode, the second electrode 402 may refer to a drain electrode, and the control electrode 403 may refer to a gate electrode.

In an embodiment, the fifth transistor 410 may have a first electrode 411, a second electrode 412, and a control electrode 413, and may be connected between the first control electrode 313 of the first transistor 310 and the second voltage line 143. The first electrode 411 of the fifth transistor 410 may be electrically connected to the second voltage line 143, and the second electrode 412 of the fifth transistor 410 may be electrically connected to the first control electrode 313 of the first transistor 310.

In an embodiment, the second electrode 412 of the fifth transistor 410 and the first control electrode 313 of the first transistor 310 may be connected through the third reference node 393.

In an embodiment, the control electrode 413 of the fifth transistor 410 may be electrically connected to an initialization scan line 440. The fifth transistor 410 may obtain an initialization scan signal through the initialization scan line 440.

In an embodiment, the pixel 300 shown in FIG. 4 is a pixel located in the n-th row among the plurality of pixels, and the scan line 360 may be an n-th scan line connected to pixels located in the n-th row of the plurality of scan lines. The plurality of scan lines may receive scan signals sequentially from a scan line located in the first row to scan lines located in the subsequent rows.

In an embodiment, the initialization scan line 440 may be a previous scan line in the (n−1)-th row. In an embodiment, the initialization scan signal may be applied as a scan signal to the pixels located in the (n−1)-th row.

In an embodiment, the first electrode 411 of the fifth transistor 410 may refer to a source electrode, the second electrode 412 may refer to a drain electrode, and the control electrode 413 may refer to a gate electrode.

In an embodiment, the sixth transistor 420 may have a first electrode 421, a second electrode 422, and a control electrode 423, and may be connected between the second control electrode 314 of the first transistor 310 and a first initialization line 450. The first electrode 421 of the sixth transistor 420 may be electrically connected to the first initialization line 450, and the second electrode 422 of the sixth transistor 420 may be electrically connected to the second control electrode 314 of the first transistor 310.

In an embodiment, the second electrode 422 of the sixth transistor 420 and the second control electrode 314 of the first transistor 310 may be connected through the first reference node 391.

In an embodiment, the control electrode 423 of the sixth transistor 420 may be electrically connected to the light emitting line 430. The sixth transistor 420 may obtain a light emitting signal through the light emitting line 430.

In an embodiment, the control electrode 403 of the fourth transistor 400 and the control electrode 423 of the sixth transistor 420 may be electrically connected to the light emitting line 430 that provides the same light emitting signal.

In an embodiment, the first electrode 421 of the sixth transistor 420 may refer to a source electrode, the second electrode 422 may refer to a drain electrode, and the control electrode 423 may refer to a gate electrode.

In an embodiment, the number of transistors included in the pixel 300 is not limited to the number illustrated in FIGS. 3-4. In some embodiments, at least one of the first to sixth transistors 310, 320, 330, 400, 410 and 420 may be omitted. In some embodiments, one or more transistors may further be included in the pixel 300.

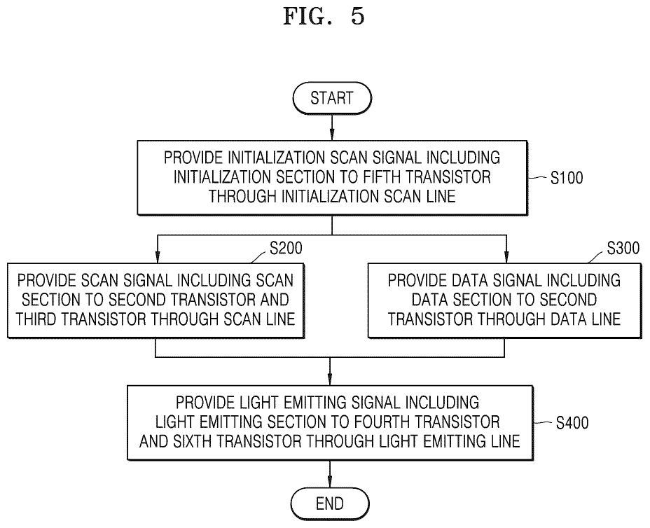

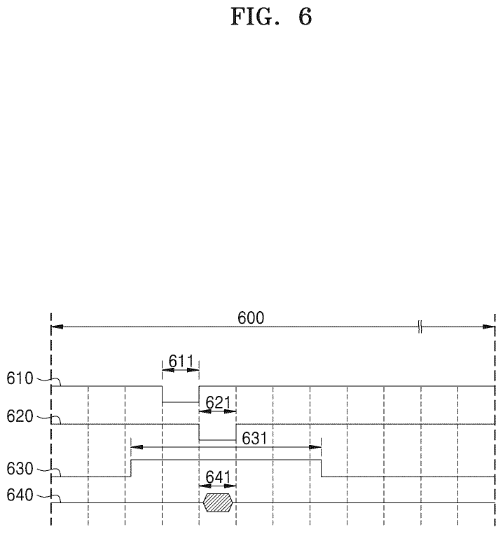

FIG. 5 is a flowchart for describing a method of operating an electronic device to operate a pixel, according to an embodiment. FIG. 6 is a timing chart of driving signals to operate a pixel, according to an embodiment.

Referring to FIGS. 1, 2, 4 and 5, in an embodiment, a method of operating the electronic device 100 may include displaying the image 120 through the display 110 including the plurality of pixels 150.

Referring to FIGS. 5 and 6, in an embodiment, the electronic device 100 may control the display 110 to display the image 120 over a plurality of frames. The display 110 may display the image for a light emitting section of a light emitting signal 630.

In an embodiment, the plurality of scan lines 140, the plurality of light emitting lines and the plurality of initialization scan lines may be sequentially scanned in one frame 600.

In an embodiment, the scan signal provided to each scan line, the light emitting signal provided to each light emitting line and the initialization scan signal provided to each initialization scan line may have a low level in some sections and a high level in some other sections in the frame 600.

In an embodiment, p-type transistors may be turned on when a signal provided to the control electrode of the p-type transistor has a low level. The p-type transistors may be turned off when the signal provided to the control electrode of the p-type transistor has a high level. In an embodiment, n-type transistors may be turned on when the signal provided to the control electrode of the n-type transistor has the high level. The n-type transistors may be turned off when the signal provided to the control electrode of the n-type transistor has the low level.

In an embodiment, the high-level section of the light emitting signal 630 may be defined as a light-emitting section, and the low-level section may be defined as a non-light-emitting section 631.

In an embodiment, the displaying of the image 120 may include providing the initialization scan signal 610 including an initialization section 611 to the fifth transistor 410 through the initialization scan line 440 within one frame 600, in operation S100.

In operation S100, the electronic device 100 may provide the initialization scan signal 610 including the initialization section 611 to the fifth transistor 410 through the initialization scan line 440. The electronic device 100 may control the scan driver 133 to provide the initialization scan signal 610 to the fifth transistor 410 through the initialization scan line 440.

In an embodiment, the low-level section of the initialization scan signal 610 may be defined as the initialization section 611. The initialization section 611 may overlap the non-light-emitting section 631.

In an embodiment, as the fifth transistor 410 is turned on in the initialization section 611, a second driving voltage VSS may be delivered to the third reference node 393 through the fifth transistor 410. Accordingly, a second driving voltage VSS may be applied to the first control electrode 313 of the first transistor 310 electrically connected to the third reference node 393. The voltage at the first control electrode 313 of the first transistor 310 may be initialized to the second driving voltage VSS.

In an embodiment, the displaying of the image 120 may include providing the scan signal 620 including a scan section 621 to the second transistor 320 and the third transistor 330 through the scan line 360 within one frame, in operation S200.

In operation S200, the electronic device 200 may provide the scan signal 620 including the scan section 621 to the second transistor 320 and the third transistor 330 through the scan line 360. The electronic device 100 may control the scan driver 133 to provide the scan signal 620 to the second transistor 320 and the third transistor 330 through the scan line 360.

In an embodiment, the low-level section of the scan signal 620 may be defined as the scan section 621. The scan section 621 may overlap the non-light-emitting section 631. The initialization section 611 may precede the scan section 621. The initialization section 611 may precede the data section 641.

In an embodiment, the displaying of the image 120 may include providing a data signal 640 including the data section 641 to the third transistor 330 through the data line 370 within the one frame, in operation S300.

In operation S300, the electronic device 100 may provide the data signal 640 including the data section 641 to the third transistor 330 through the data line 370. The electronic device 100 may control the data driver 132 to provide the data signal 640 to the third transistor 330 through the data line 370.

In an embodiment, the data section 641 may be a section in which a plurality of data signals converted into an analog voltage to correspond to a gray level of an output image signal are provided. In an embodiment, the data section 641 may include signals with various levels of voltages.

In an embodiment, the data section 641 may overlap the non-light-emitting section 631. The data section 641 may overlap the scan section 621.

In an embodiment, as the third transistor 330 is turned on in the scan section 621, a data voltage Vdata included in the data section 641 may be delivered to the first reference node 391 through the third transistor 330. Accordingly, the data voltage Vdata is also applied to the second control electrode 314 of the first transistor 310 electrically connected to the first reference node 391.

In an embodiment, a threshold voltage that is a unique characteristic of the first transistor 310 may be referred to as Vth0. In an embodiment, as the data voltage Vdata is applied to the second control electrode 314 of the first transistor 310, the threshold voltage to be considered in determining the intensity of a current flowing through the first transistor 310 may be changed, and the changed threshold voltage may be referred to as an active threshold voltage Vth_eff.

In an embodiment, when the first driving voltage at the first electrode 311 of the first transistor 310 is VDD, the active threshold voltage Vth_eff of the first transistor 310 may be determined in equation 1 below:

$$Vth\_eff = Vth 0 + α ( VDD - Vdata ) \qquad Equation 1$$

where α may be determined by a distance between the second control electrode 314 and a channel included in the first transistor 310. The value amay be determined to be inversely proportional to thickness of an insulation layer arranged between the second control electrode 314 and the channel. In an embodiment, the thicker the insulation layer arranged between the second control electrode 314 and the channel, the smaller the size of a.

In an embodiment, as the second transistor 320 is turned on in the scan section 621, the first transistor 310 may be diode-connected and accordingly, forward-biased. Accordingly, a compensation voltage VDD+Vth_eff may be applied to the first control electrode 313 of the first transistor 310 based on the first driving voltage VDD applied to the first electrode 311 of the first transistor 310 and the active threshold voltage Vth_eff of the first transistor 310. In this case, the compensation voltage may be VDD+Vth0+α(VDD−Vdata).

In an embodiment, although the operation S200 and the operation S300 are shown as being performed separately, embodiments are not limited thereto. It will be understood that the operation S200 and the operation S300 may also be performed in one step.

In an embodiment, the displaying of the image 120 may include providing the light emitting signal 630 including a light emitting section to the fourth transistor 400 and the sixth transistor 420 through the light emitting line 430 within the one frame, in S400.

In operation S400, the electronic device 100 may provide the light emitting signal 630 including the light emitting section to the fourth transistor 400 and the sixth transistor 420 through the light emitting line 430. The electronic device 100 may control the light emitting driver 134 to provide the light emitting signal 630 to the fourth transistor 400 and the sixth transistor 420 through the light emitting line 430.

In an embodiment, the light emitting section may be a section of the light emitting signal 630 other than the non-light-emitting section 631. The light emitting section may not overlap the initialization section 611, the scan section 621 and the data section 641.

In an embodiment, as the sixth transistor 420 is turned on in the light emitting section, a first initialization voltage Vref may be delivered to the first reference node 391 through the sixth transistor 420. Accordingly, the first initialization voltage Vref is also applied to the second control electrode 314 of the first transistor 310 electrically connected to the first reference node 391.

In an embodiment, when the voltage at the second control electrode 314 of the first transistor 310 is changed to the first initialization voltage Vref, the active threshold voltage Vth_eff of the first transistor 310 may be determined in equation 2 below:

$$Vth\_eff = Vth 0 + α ( VDD - Vref ) \qquad Equation 2$$

In an embodiment, as the fifth transistor 410 is turned on in the light emitting section, a driving current Ids based on a difference in voltage between the first control electrode 313 of the first transistor 310 and the first electrode 311 may be provided to the light emitting diode 340 through the fifth transistor 410. The light emitting diode 340 may generate light according to the provided driving current Ids, and thus, the display 110 may display the image 120.

Furthermore, in an embodiment, the pixel 300 may include a driving capacitor having a first electrode electrically connected to the first voltage line 142 and a second electrode electrically connected to the first reference node 391. The first driving voltage VDD may be applied to the first electrode of the driving capacitor through the first voltage line 142, and the first initialization voltage Vref may be applied to the second electrode of the driving capacitor through the first reference node 391.

As the first driving voltage VDD and the first initialization voltage Vref are applied to the first electrode and second electrode of the driving capacitor by the nature of the capacitor, the active threshold voltage Vth_eff of the first transistor 310 may be prevented from being changed by an external influence or a parasitic capacitor in the pixel 300 in the voltage light emitting section. Accordingly, the driving current Ids may be prevented from being changed in magnitude and the stable driving current Ids may be provided to the light emitting diode 340.

In an embodiment, according to the voltage-current characteristics of the first transistor 310, the driving current Ids of the first transistor 310 may be proportional to (Vgs−Vth_eff)², which is the square of a value obtained by subtracting the active threshold voltage Vth_eff of the first transistor 310 from a difference Vgs between the voltage at the first control electrode 313 of the first transistor 310 and the voltage of the first electrode 311.

In an embodiment, the voltage at the first control electrode 313 of the first transistor 310 may be the compensation voltage VDD+Vth0+α(VDD−Vdata) applied in operations S200 and S300. The voltage at the first electrode 311 of the first transistor 310 may be the first driving voltage VDD. The active threshold voltage Vth_eff of the first transistor 310 may be Vth0+α(VDD−Vref) according to equation 2.

In an embodiment, the value obtained by subtracting the active threshold voltage Vth_eff of the first transistor 310 from the difference Vgs between the voltage at the first control electrode 313 of the first transistor 310 and the voltage at the first electrode 311 may be −α(Vdata−Vref). Accordingly, in operation S400, the driving current Ids of the first transistor 310 provided to the light emitting diode 340 may be proportional to (α(Vdata−Vref))².

In an embodiment, in operation S400, the driving current Ids provided to the light emitting diode 340 may be determined regardless of the threshold voltage Vth0, which is a characteristic of the first transistor 310, and the first driving voltage VDD.

As each of the plurality of pixels 150 included in the electronic device 100 of the disclosure has the second control electrode 314 of the first transistor 310 electrically connected to the data line 370, the active threshold voltage Vth0 obtained by reflecting the data voltage Vdata on the threshold voltage Vth_eff of the first transistor 310 may be sensed through diode connection of the first transistor 310.

Furthermore, as each of the plurality of pixels 150 included in the electronic device 100 of the disclosure has the control electrode 323 of the second transistor 320 and the control electrode 333 of the third transistor 330 electrically connected to the scan line 360 that provides the same scan signal, the compensation voltage VDD+Vth0+α(VDD−Vdata) including both the data voltage Vdata and the threshold voltage Vth0 may be applied to the first control electrode 313 of the first transistor 310 in one scan section 621.

In the subsequent light-emitting section, the driving current Ids that flows through the first transistor 310 may be determined to be proportional to (α(Vdata−Vref))², which is unrelated to the threshold voltage Vth0 and the first driving voltage VDD of the first transistor 310.

Accordingly, the electronic device 100 including the display 110 having the pixel structure according to an embodiment may provide the image 120 that provides uniform brightness without brightness unevenness due to a deviation of the threshold voltage Vth0 of the first transistor 310 depending on the driving reliability and the process deviation and a deviation of the first driving voltage VDD depending on the location of the pixel in the display 110.

Furthermore, since the electronic device 100 according to an embodiment is configured to control the second transistor 320 and the third transistor 330 simultaneously through the one scan line 360 in configuring a circuit of the pixel such that the driving current Ids flowing through the first transistor 310 is unrelated to the threshold voltage Vth0 and the first driving voltage VDD of the first transistor 310, additional wiring is not required, and a section in which to turn on an additional transistor is not required within one frame.

Moreover, since the electronic device 100 according to an embodiment provides the data voltage Vdata to the second control electrode 314 of the first transistor 310 through the third transistor 330 and provides the first initialization voltage Vref through the second transistor 420, the electronic device 100 does not require an extra transistor or additional wiring, a section in which to turn on the extra transistor within one frame, etc., to reduce the influence of the first driving voltage VDD on the driving current Ids flowing through the first transistor 310 by changing the active threshold voltage Vth_eff of the first transistor 310.

Accordingly, the electronic device 100 according to an embodiment may increase the aperture ratio of the pixel 300 by reducing the number of transistors and the number of line wirings included in the pixel 300 required to provide the image 120 having uniform brightness. Furthermore, the electronic device 100 according to an embodiment may reduce a compensation section required in one frame to provide the image 120 with uniform brightness, thereby obtaining sufficient length of the data section to provide data to the pixel 300, which is advantageous for high-speed operation.

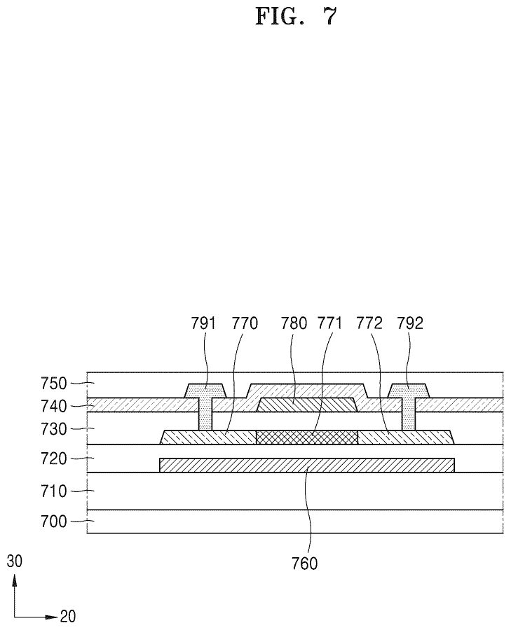

FIG. 7 is a cross-sectional view of the display 110 for describing a structure of a first transistor, according to an embodiment.

Referring to FIGS. 4 and 7, in an embodiment, the display 110 may include a base layer 700, a buffer layer 710, a first insulation layer 720, a second insulation layer 730, a third insulation layer 740 and an encapsulation layer 750. The base layer 700, the buffer layer 710, the first insulation layer 720, the second insulation layer 730, the third insulation layer 740 and the encapsulation layer 750 included in the display 110 may arranged by being stacked in the third direction 30.

In an embodiment, the display 110 may include a plurality of transistors and a plurality of light emitting diodes. For convenience of explanation, in the cross-sectional view of FIG. 7, one transistor and one light emitting diode are shown. In an embodiment, the transistor included in the cross-sectional view of FIG. 7 may be the first transistor 310.

In an embodiment, the base layer 700 may include a synthetic resin layer. The synthetic resin layer may include a thermosetting resin. In an embodiment, the synthetic resin layer may be a polyimide-based resin layer, but the material is not particularly limited. The synthetic resin layer may include at least one of acrylic resin, methacrylic resin, polyisoprene, vinyl resin, epoxy resin, urethane resin, cellulose resin, siloxane resin, polyamide resin or perylene resin. Moreover, the base layer 700 may include a glass substrate, a metal substrate or an organic/inorganic composite material substrate.

In an embodiment, the buffer layer 710 may be arranged on the top of the base layer 700. The buffer layer 710 may include an inorganic layer. The inorganic layer may include at least one of aluminum oxide, titanium oxide, silicon oxide, silicon oxynitride, zirconium oxide, or hafnium oxide. The inorganic layer may be formed with multiple layers. The multiple inorganic layers may constitute barrier layers BR1 and BR2 and/or a buffer layer BFL. The barrier layers BR1 and BR2 and the buffer layer BFL may be optionally arranged.

In an embodiment, the buffer layer 710 may be a layer to prevent foreign materials from being brought into the display 110 from outside the display 110. In an embodiment, the buffer layer 710 may be a layer to increase bonding force between the base layer 700 and a semiconductor pattern and/or conductive pattern. The buffer layer 710 may include a silicon oxide layer and a silicon nitride layer. Each of them may be provided in the plural, and the silicon oxide layers and the silicon nitride layers may be alternately stacked.

In an embodiment, a first gate electrode 760 may be arranged on the buffer layer 710. The first gate electrode 760 may correspond to the second control electrode 314 of the first transistor 310.

In an embodiment, the first gate electrode 760 may overlap at least a portion of the semiconductor patterns 770, 771 and 772. The first gate electrode 760 may protect the semiconductor patterns 770, 771 and 772 from light entering through the base layer 700. The first gate electrode 760 may be arranged underneath the first transistor 310 to prevent degradation of current-voltage characteristics of the semiconductor patterns 770, 771 and 772 from external light. With this configuration, the display 110 may be provided to have enhanced reliability. In an embodiment, the first gate electrode 760 may correspond to a bottom gate of the first transistor 310.

In an embodiment, the first gate electrode 760 may include titanium (Ti), silver (Ag), an alloy containing silver, molybdenum (Mo), an alloy containing molybdenum, aluminum (Al), an alloy containing aluminum, aluminum nitride (AIN), tungsten (W), tungsten nitride (WN), copper (Cu), indium tin oxide (ITO), indium zinc oxide (IZO), etc., but embodiments are not particularly limited thereto.

Although not shown in FIG. 7, the first gate electrode 760 may be electrically connected to the data line 370. The data line 370 may be arranged on the same layer as the first gate electrode 760 or arranged on a different layer from the first gate electrode 760 which may be electrically connected to the data line 370 through a connection electrode.

In an embodiment, the first insulation layer 720 may be arranged on the buffer layer 710. The first insulation layer 720 may be arranged to extend from the first gate electrode 760 and may cover the first gate electrode 760. The first insulation layer 720 may be a gate insulation layer of the second control electrode 314 of the first transistor 310.

The first insulation layer 720 may be an inorganic layer and/or organic layer, and may have a single-layered or multiple-layered structure. The first insulation layer 720 may include at least one of aluminum oxide, titanium oxide, silicon oxide, silicon nitride, silicon oxynitride, zirconium oxide, or hafnium oxide. In the embodiment, the first insulation layer 720 may be a single-layered silicon oxide layer.

In an embodiment, the semiconductor patterns 770, 771 and 772 may be arranged on the first insulation layer 720. The semiconductor patterns 770, 771 and 772 may be divided into the source area 770, the gate area 771 and the drain area 772 according to the doping concentration or conductivity of the semiconductor patterns. In an embodiment, the source area 770 and the drain area 772 may be a p-type semiconductor layer. The gate area 771 may be an active layer or channel layer arranged between the source area 770 and the drain area 772.

In an embodiment, the semiconductor patterns 770, 771 and 772 may include silicon semiconductors. For example, in some embodiments, the silicon semiconductors may include amorphous silicon, polycrystalline silicon, etc. In some embodiments, the semiconductor patterns 770, 771 and 772 may include oxides of materials selected from group 12, 13, and 14 metals such as indium (In), gallium (Ga), tin (Sn), cadmium (Cd), aluminum (Al), germanium (Ge), zinc (Zinc), or hafnium (Hf), and combinations thereof.

In an embodiment, the second insulation layer 730 may be arranged on the first insulation layer 720. The second insulation layer 730 may cover the semiconductor patterns 770, 771 and 772. The second insulation layer 730 may be a gate insulation layer of the first control electrode 313 of the first transistor 310.

The second insulation layer 730 may be an inorganic layer and/or organic layer, and may have a single-layered or multiple-layered structure. The second insulation layer 730 may include at least one of aluminum oxide, titanium oxide, silicon oxide, silicon nitride, silicon oxynitride, zirconium oxide, or hafnium oxide.

In an embodiment, the second insulation layer 730 may include a general-purpose polymer such as Benzocyclobutene (BCB), polyimide, Hexamethyldisiloxane (HMDSO), Polymethylmethacrylate (PMMA), or Polystyrene (PS), a polymer derivative having a phenolic group, an acrylic polymer, an imide polymer, an aryl ether polymer, an amide polymer, a fluorine-based polymer, a p-xylene-based polymer, a vinyl alcohol-based polymer, and blends thereof, but embodiments are not particularly limited thereto.

In an embodiment, a second gate electrode 780 may be arranged on the second insulation layer 730. The second gate electrode 780 may correspond to the first control electrode 313 of the first transistor 310. The second gate electrode 780 may be arranged on the semiconductor patterns 770, 771 and 772. The second gate electrode 780 may overlap the gate area 771. In an embodiment, the second gate electrode 780 may correspond to a top gate of the first transistor 310.

In one embodiment, the second gate electrode 780 may include titanium (Ti), silver (Ag), an alloy containing silver, molybdenum (Mo), an alloy containing molybdenum, aluminum (Al), an alloy containing aluminum, aluminum nitride (AIN), tungsten (W), tungsten nitride (WN), copper (Cu), indium tin oxide (ITO), indium zinc oxide (IZO), etc., but embodiments are not particularly limited thereto.

In an embodiment, the first transistor 310 may have a double gate structure in which the operation is controlled through the first control electrode 313 and the second control electrode 314 arranged on and underneath the semiconductor patterns 770, 771 and 772, respectively. Accordingly, the first transistor 310 may have high driving speed and high charge mobility as compared to a case of including a single control electrode.

In an embodiment, the third insulation layer 740 may be arranged on the second insulation layer 730. The third insulation layer 740 may cover the second gate electrode 780. The third insulation layer 740 may have a single- or multiple-layered structure. The third insulation layer 740 may be an inorganic layer and/or an organic layer.

In an embodiment, a source electrode 791 and a drain electrode 792 may be arranged on the third insulation layer 740.

In an embodiment, the source electrode 791 may be electrically connected to the source area 770 through a through hole that penetrates the second insulation layer 730 and the third insulation layer 740. Embodiments are not, however, limited thereto, and in some embodiments, the source electrode 791 may be electrically connected to the source area 770 through a connection electrode that penetrates the second insulation layer 730 and the third insulation layer 740.

In an embodiment, the drain electrode 792 may be electrically connected to the drain area 772 through a through hole that penetrates the second insulation layer 730 and the third insulation layer 740. Embodiments are not, however, limited thereto, and in some embodiments, the drain electrode 792 may be electrically connected to the drain area 772 through the connection electrode that penetrates the second insulation layer 730 and the third insulation layer 740.

In an embodiment, the encapsulation layer 750 may be arranged on the third insulation layer 740. The encapsulation layer 750 may encapsulate a plurality of circuit devices and a light emitting diode arranged under the encapsulation layer.

In an embodiment, the encapsulation layer 750 may include at least one organic film and at least one inorganic film. The inorganic film may include an inorganic material and protect the light emitting diode against moisture/oxygen. The inorganic film may include a silicon nitride layer, a silicon oxynitride layer, a silicon oxide layer, a titanium oxide layer, or an aluminum oxide layer, but is not particularly limited thereto. The organic layer may include an organic material and protect the light emitting diode against foreign materials such as dust particles.

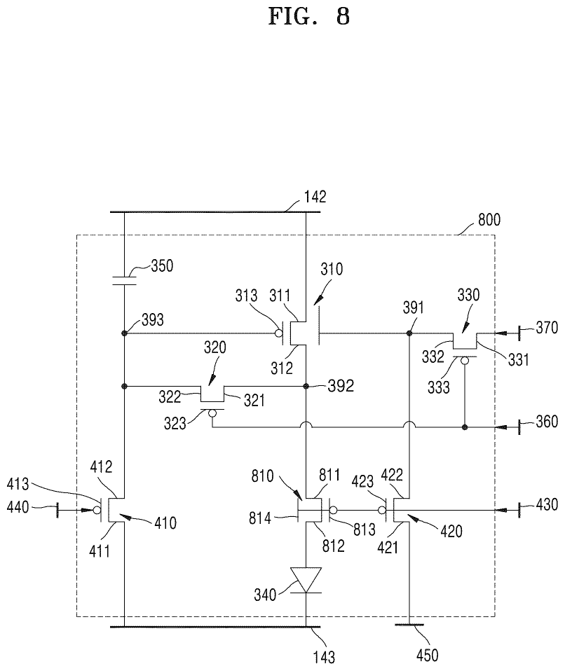

FIG. 8 is an equivalent circuit diagram of a pixel, according to an embodiment. The same components as described in FIGS. 3 and 4 will be given the same reference numerals but the description thereof will be omitted for conciseness.

Referring to FIGS. 4, 6 and 8, in an embodiment, a pixel 800 may include the first transistor 310, the second transistor 320, the third transistor 330, a fourth transistor 810, the fifth transistor 410, the sixth transistor 420, the light emitting diode 340 and the capacitor 350.

In an embodiment, the fourth transistor 810 may have a first electrode 811, a second electrode 812, a first control electrode 813 and a second control electrode 814, and may be connected between the anode of the light emitting diode 340 and the second electrode 312 of the first transistor 310. The first electrode 811 of the fourth transistor 810 may be electrically connected to the second electrode 312 of the first transistor 310, and the second electrode 812 of the fourth transistor 810 may be electrically connected to the anode of the light emitting diode 340.

In an embodiment, the fourth transistor 810 may include the first control electrode 813 and the second control electrode 814. In an embodiment, the first control electrode 813 and the second control electrode 814 of the fourth transistor 810 may each be electrically connected to the light emitting line 430 that provides a light emitting signal. The fourth transistor 810 may obtain a light emitting signal through the light emitting line 430.

In an embodiment, the first electrode 811 of the fourth transistor 810 may refer to a source electrode, the second electrode 812 may refer to a drain electrode, and the first control electrode 813 and the second control electrode 814 may each refer to a gate electrode.

In an embodiment, the fourth transistor 800 may have a double gate structure that controls operations through the first control electrode 813 and the second control electrode 814. In an embodiment, one of the first control electrode 813 and the second control electrode 814 may be located on a channel included in the fourth transistor 800 and the other control electrode may be located underneath the channel included in the fourth transistor 800.

Accordingly, the fourth transistor 800 may have high driving speed and high charge mobility as compared to a case of including a single control electrode.

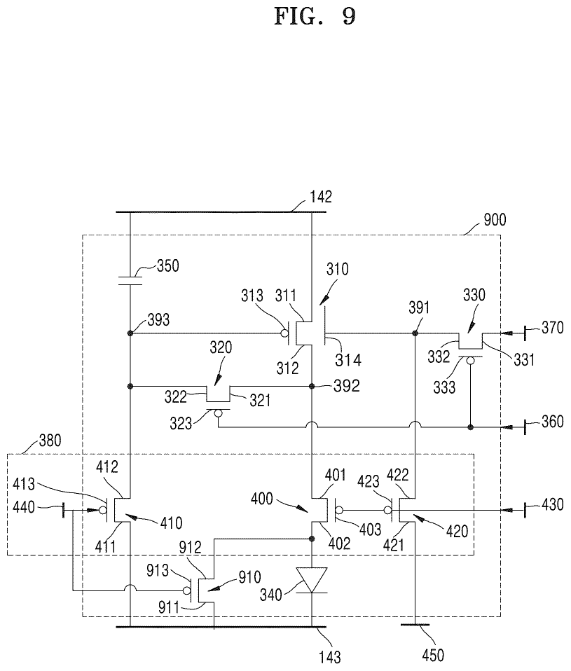

FIG. 9 is an equivalent circuit diagram of a pixel, according to an embodiment. The same components as described in FIGS. 3 and 4 will be given the same reference numerals but the description thereof will be omitted for conciseness.

Referring to FIGS. 4, 6 and 9, in an embodiment, a pixel 900 may include the first transistor 310, the second transistor 320, the third transistor 330, the fourth transistor 400, the fifth transistor 410, the sixth transistor 420, a seventh transistor 910, the light emitting diode 340 and the capacitor 350.

In an embodiment, the seventh transistor 910 may include a first electrode 911, a second electrode 912, and a control electrode 913, and may be connected between the anode of the light emitting diode 340 and the second voltage line 143. The first electrode 911 of the seventh transistor 910 may be electrically connected to the second voltage line 143, and the second electrode 912 of the seventh transistor 910 may be electrically connected to the anode of the light emitting diode 340.

In an embodiment, the control electrode 913 of the seventh transistor 910 may be electrically connected to the initialization scan line 440. The seventh transistor 910 may obtain the initialization scan signal 610 through the initialization scan line 440.

In an embodiment, as the seventh transistor 910 is turned on in the initialization section 611, a second driving voltage may be provided to the anode of the light emitting diode 340 through the seventh transistor 910. In this case, the second driving voltage may initialize the voltage applied in the previous frame and remaining at the anode of the light emitting diode 340.

In an embodiment, since the voltage at the anode of the light emitting diode 340 is initialized through the seventh transistor 910, the light emitting diode 340 may be prevented from instantaneously emitting light with high brightness due to the voltage left at the anode of the light emitting diode 340 in an early stage of operation of the light emitting diode 340 in the light-emitting section.

Embodiments are not, however, limited thereto, and in some embodiments, the control electrode 913 of the seventh transistor 910 may be electrically connected to the scan line 360. In this case, the seventh transistor 910 may obtain the scan signal 620 through the scan line 360, and may be turned on in the scan section 621 to provide the second driving voltage to the anode of the light emitting diode 340.

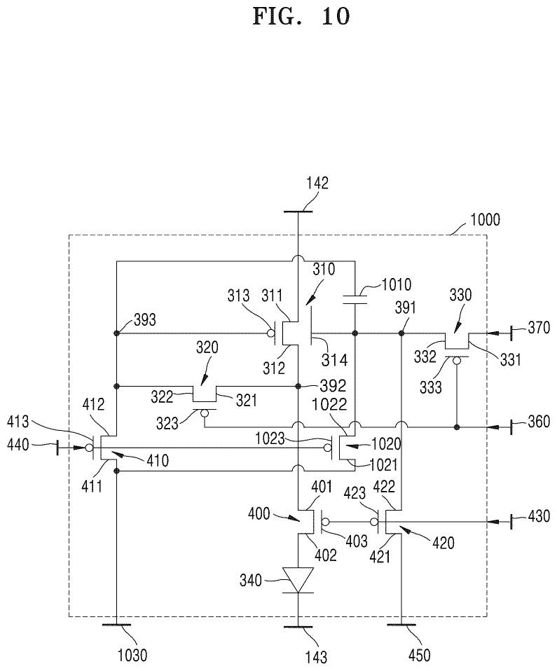

FIG. 10 is an equivalent circuit diagram of a pixel, according to an embodiment. The same components as described in FIGS. 3 and 4 will be given the same reference numerals but the description thereof will not be repeated.

Referring to FIGS. 4, 6 and 10, in an embodiment, a pixel 1000 may include the first transistor 310, the second transistor 320, the third transistor 330, the fourth transistor 400, the fifth transistor 410, the sixth transistor 420, an eighth transistor 1020, the light emitting diode 340 and a capacitor 1010.

In an embodiment, the capacitor 1010 may have a first electrode and a second electrode, and may be connected between the first control electrode 313 of the first transistor 310 and the second control electrode 314 of the first transistor 310. The first electrode of the capacitor 1010 may be electrically connected to the first control electrode 313 of the first transistor 310, and the second electrode 322 of the capacitor 1010 may be electrically connected to the second control electrode 314 of the first transistor 310.

In an embodiment, the fifth transistor 410 may be connected between the first control electrode 313 of the first transistor 310 and a second initialization line 1030. The first electrode 411 of the fifth transistor 410 may be electrically connected to the second initialization line 1030 that provides the second initialization voltage, and the second electrode 412 of the fifth transistor 410 may be electrically connected to the first control electrode 313 of the first transistor 310.

In an embodiment, the control electrode 413 of the fifth transistor 410 may be electrically connected to the initialization scan line 440. The fifth transistor 410 may obtain an initialization scan signal through the initialization scan line 440.

In an embodiment, the first electrode 411 of the fifth transistor 410 may refer to a source electrode, the second electrode 412 may refer to a drain electrode, and the control electrode 413 may refer to a gate electrode.

In an embodiment, the eighth transistor 1020 may include a first electrode 1021, a second electrode 1022, and a control electrode 1023, and may be connected between the second control electrode 314 of the first transistor 310 and the second initialization line 1030. The first electrode 1021 of the eighth transistor 1020 may be electrically connected to the second initialization line 1030, and the second electrode 1022 of the eighth transistor 1020 may be electrically connected to the second control electrode 314 of the first transistor 310.

In an embodiment, the control electrode 1023 of the eighth transistor 1020 may be electrically connected to the initialization scan line 440. The eighth transistor 1020 may obtain the initialization scan signal through the initialization scan line 440.

In an embodiment, the first electrode 1021 of the eighth transistor 1020 may refer to a source electrode, the second electrode 1022 may refer to a drain electrode, and the control electrode 1023 may refer to a gate electrode.

In an embodiment, the fifth transistor 410 and the eighth transistor 1020 may each be turned on in the initialization section 611. As the fifth transistor 410 is turned on, the second initialization voltage may be provided to the first control electrode 313 of the first transistor 310. As the eighth transistor 1020 is turned on, the second initialization voltage may be provided to the second control electrode 314 of the first transistor 310.

In an embodiment, the second initialization voltage may be to initialize the voltage applied in the previous frame and left at the first control electrode 313 and the second control electrode 314 of the first transistor 310.

In an embodiment, the second initialization voltage may be equal to the first initialization voltage Vref applied to the first initialization line 450. Embodiments are not, however, limited thereto, and in some embodiments, the second initialization voltage may be equal to the second driving voltage or may be a different level of voltage at which to perform initializing the voltage left at the first control electrode 313 and the second control electrode 314 of the first transistor 310.

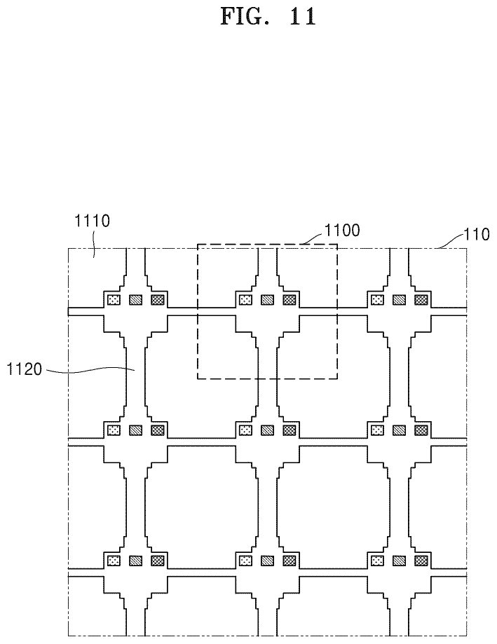

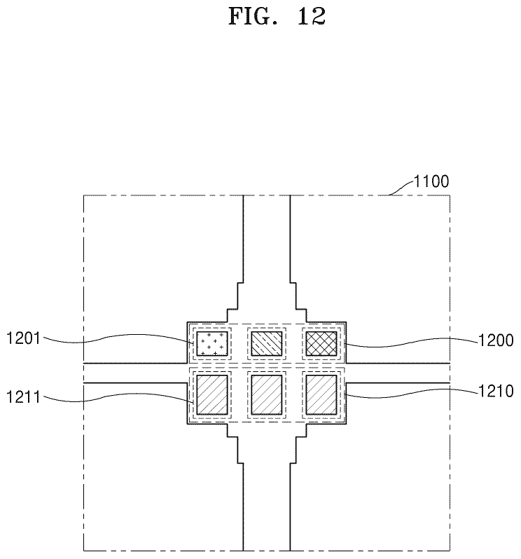

FIG. 11 is a diagram for describing a layout of pixels, according to an embodiment. FIG. 12 is an enlarged diagram for describing a layout of a pixel, according to an embodiment.

Referring to FIGS. 2, 4 and 11, in an embodiment, some of the plurality of pixels 150 and wires connected to the plurality of pixels included in the display 110 are shown in FIG. 11.

In an embodiment, the display 110 may include a transmission area 1110 and a non-transmission area 1120. The non-transmission area may be an area where devices or circuit components that are opaque to light such as the plurality of wires or circuit elements including transistors are arranged. In an embodiment, the transmission area 1110 may be an area where transparent or translucent components such as a transparent electrode or translucent electrode, an insulation layer, etc., are arranged.

In an embodiment, the higher the proportion of the transmission area 1110 in the display 110 is than a proportion of the non-transmission area 1120, the higher the ratio of light provided to the outside of the display 110 to light provided from the light emitting diode is, brightness of the display 110 may increase and power consumption may be reduced. That is, when the transmission area 1110 takes up a higher portion of the display 110 than the non-transmission area 1120, the ratio of light provided to the outside of the display 110 from the light emitting diodes is higher, and the brightness of the display 110 increases and power consumption is reduced.

In an embodiment, FIG. 12 shows an enlarged portion 1100 of the display 110 shown in FIG. 11.

In an embodiment, the display 110 may include a pixel area 1200 where a plurality of light emitting diodes are arranged and a circuit area 1210 where a plurality of circuit elements to drive the plurality of light emitting diodes are arranged.

In an embodiment, a plurality of sub-light emitting diodes that generate different colors of light may be arranged in the pixel area 1200. The pixel area 1200 may include a plurality of sub-pixel areas 1201 where the plurality of sub-light emitting diodes are arranged, respectively.

In an embodiment, the circuit area 1210 may have a plurality of sub-pixel circuits arranged to correspond to the plurality of sub-light emitting diodes, respectively, to control operations of the plurality of sub-light emitting diodes. The circuit area 1210 may include a plurality of sub-pixel circuit areas 1211 where the plurality of sub-pixel circuits are arranged, respectively.

In an embodiment, one sub-light emitting diode (e.g., the sub-light emitting diode in sub-pixel area 1201) may correspond to the light emitting diode 340 shown in FIG. 4. A sub-pixel circuit to control operation of the one sub-light emitting diode may include the first to sixth transistors 310, 320, 330, 400, 410 and 420 and the capacitor 350 shown in FIG. 4 and may be disposed in, for example, the sub-pixel circuit area 1211 corresponding to the sub-pixel area 1201. Furthermore, the sub-pixel circuit may include wires electrically connected to the respective circuit components.

In an embodiment, the circuit area 1210 may correspond to the non-transmission area 1120. The non-transmission area may include a wiring area where the plurality of wires that extend from the data driver 132, the scan driver 133 and the light emitting driver 134 to be electrically connected to the plurality of sub-pixel circuits are arranged.

Each of the plurality of pixels 150 included in the electronic device 100 according to an embodiment includes a second transistor 320 and a third transistor 330 simultaneously controlled through the scan line 360 to prevent unevenness of brightness due to a deviation of the threshold voltage Vth0 of the first transistor 310 depending on the driving reliability and the process deviation and a deviation of the first driving voltage VDD depending on the location of the pixel in the display 110.

Furthermore, by providing the data voltage Vdata to the second control electrode 314 of the first transistor 310 through the third transistor 330 and providing the first initialization voltage Vref through the second transistor 320, it does not require an extra transistor or additional wiring, a section in which to turn on the extra transistor within one frame, etc., to reduce the influence of the first driving voltage VDD on the driving current Ids flowing through the first transistor 310.

Accordingly, the electronic device 100 according to an embodiment may increase the maximum brightness of the display 110 and reduce the power consumption by reducing the number of transistors and the number of line wirings included in the pixel 300 required to provide the image 120 having uniform brightness and thus, reducing the proportion of the non-transmission area 1120 in the display 110.

FIG. 13 is a block diagram for describing a configuration of an electronic device, according to an embodiment.

Referring to FIGS. 1 and 13, in an embodiment, an electronic device 1300 may include a display 1310, a memory 1320, at least one processor 1330, an input/output interface 1340 and a communication interface 1350.

However, not all the components shown in FIG. 13 are essential. In an embodiment, the electronic device 1300 may be implemented with more or fewer components than in FIG. 13.

The display 1310, the memory 1320, the at least one processor 1330, the input/output interface 1340 and the communication interface 1350 included in the electronic device 1300 may be electrically connected to one another.

In an embodiment, the display 1310 may include the plurality of pixels 150 described with reference to FIGS. 1-12. In an embodiment, each of the plurality of pixels 150 included in the display 1310 may include a light emitting diode such as an organic light emitting diode. Embodiments are not, however, limited thereto, and in some embodiments, each of the plurality of pixels 150 included in the display 1310 may include a light emitting diode such as an inorganic light emitting diode.

In an embodiment, instructions, a data structure and program codes that are readable to the at least one processor 1330 may be stored in the memory 1320. In an embodiment, there may be one or more memories 1320. Operations performed by the electronic device 100 may be implemented by the at least one processor 1330 executing the instructions or codes of the program stored in the memory 1320.

In an embodiment, the memory 1320 may include at least one of a flash memory type, a hard disk type, a multimedia card micro type, a card type memory (e.g., secure digital (SD) or extreme digital (XD) memory), a random access memory (RAM), a static RAM (SRAM), a read-only memory (ROM), an electrically erasable programmable ROM (EEPROM), a programmable ROM (PROM), a mask ROM, a flash ROM, a hard disc drive (HDD) and/or a solid state drive (SSD).

In an embodiment, the memory 1320 may not be separately present but integrated into the at least one processor 1330.

In an embodiment, instructions or program codes for performing functions or operations of the electronic device 100 may be stored in the memory 1320. The instructions, algorithms, data structures, program codes and application programs stored in the memory 1320 may be implemented in e.g., a programming or scripting language such as C, C++, Java, python, assembler, etc.

In an embodiment, various types of modules that may be used in performing operations of the electronic device 100 may be stored in the memory 1320.

In an embodiment, the at least one processor 1330 may be configured with one or more processors to control a series of processes for operating the electronic device 100 according to embodiments as will be described below.

In an embodiment, the at least one processor 1330 may be configured with at least one of e.g., a central processing unit (CPU), a microprocessor, a graphic processing unit (GPU), an application processor (AP), an application specific integrated circuit (ASIC), a digital signal processor (DSP), a digital signal processing device (DSPD), a programmable logic device (PLD), a field programmable gate array (FPGA) and/or a communication processor (CP), without being limited thereto.

In an embodiment, the at least one processor 1330 may be configured with a circuit such as a system on chip (SoC) or an integrated circuit (IC).

In an embodiment, the at least one processor 1330 may execute various types of modules stored in the memory 1320. The at least one processor 1330 may individually or collectively execute at least one instruction that makes up the various types of modules stored in the memory 1320. By executing the program or the at least one instruction stored in the memory 1320, the at least one processor 1330 may process data or control an operation of the electronic device 1300 according to predefined operation rules.

In an embodiment, the at least one processor 1330 may include a plurality of processors. In an embodiment, at least one of the plurality of modules in the memory 1320 may be executed by one of the plurality of processors. The other modules of the plurality of modules stored in the memory 1320 may be executed by the other processors of the plurality of processors.

In an embodiment, the at least one processor 1330 may control the input/output interface 1340 so that the electronic device 100 may obtain an image signal and a scan control signal from an external electronic device through the input/output interface 1340.

In an embodiment, the input/output interface 1340 may perform an input/output operation with the external electronic device by using at least one of input/output types including a high-definition multimedia interface (HDMI) port, a digital visual interface (DVI), a component jack, a PC port and/or a universal serial bus (USB) port. Embodiments are not, however, limited to the input/output types.

In an embodiment, the at least one processor 1330 may control the communication interface 1350 so that the electronic device 100 may perform data communication with an external server or an external device.

The communication interface 1350 may perform data communication with the external server or the external electronic device by using at least one of data communication schemes including, for example, a wireless local area network (WLAN), Wi-Fi, Bluetooth, Zigbee, WFD, infrared data association (IrDA), Bluetooth low energy (BLE), near field communication (NFC), wireless broadband Internet (Wibro), world interoperability for microwave access (WiMAX), shared wireless access protocol (SWAP), wireless gigabit alliance (WiGig) and/or radio frequency (RF) communication.

To address the technological objective, an embodiment provides an electronic device. The electronic device may include a display including a plurality of pixels. The electronic device may include a memory storing a program or at least one instruction. The electronic device may include at least one processor. The at least one processor may individually or collectively execute the program or the at least one instruction stored in the memory to cause the electronic device to control the display to display an image. One of the plurality of pixels may include a light emitting diode. One pixel may include a first transistor with a first electrode electrically connected to a first voltage line which provides a first driving voltage and a second electrode electrically connected to anode of the light emitting diode. The one pixel may include a second transistor electrically connected between a first control electrode of the first transistor and a second electrode of the first transistor. The one pixel may include a third transistor electrically connected between the second control electrode of the first transistor and a data line which provides a data signal. A control electrode of the second transistor and a control electrode of the third transistor may be electrically connected to a scan line which provides a same scan signal.

In an embodiment, the electronic device may provide a scan signal including a scan section to the second transistor and the third transistor through the scan line within one frame. The electronic device may provide a data signal including a data section to the third transistor through the data line within one frame. The data section and the scan section may overlap each other.

In an embodiment, one pixel may include a capacitor electrically connected between a first voltage line and the first control electrode of the first transistor. The one pixel may include a fourth transistor electrically connected between the anode of the light emitting diode and the second electrode of the first transistor. The control electrode of the fourth transistor may be electrically connected to a light emitting line which receives a light emitting signal.

In an embodiment, the electronic device may provide the light emitting signal including a light emitting section to the fourth transistor through the light emitting line within one frame. The light emitting section may not overlap the scan section and the data section.

In an embodiment, the one pixel may include a fifth transistor electrically connected between the first control electrode of the first transistor and the second voltage line which receives a second driving voltage. The control electrode of the fifth transistor may be electrically connected to an initialization scan line which receives an initialization scan signal.

In an embodiment, the electronic device may provide the initialization scan signal including an initialization section to the fifth transistor through the initialization scan line within one frame. The initialization section may precede the scan section.

In an embodiment, the one pixel may include a sixth transistor electrically connected between the second control electrode of the first transistor and the first initialization line which receives a first initialization voltage. The control electrode of the sixth transistor may be electrically connected to a light emitting line which receives a light emitting signal.

In an embodiment, the electronic device may provide the light emitting signal including a light emitting section to the sixth transistor through the light emitting line within one frame. The light emitting section may not overlap the scan section and the data section.

In an embodiment, one pixel may include a capacitor electrically connected between a first voltage line and the first control electrode of the first transistor. The one pixel may include a fourth transistor electrically connected between the anode of the light emitting diode and the second electrode of the first transistor. The one pixel may include a fifth transistor electrically connected between the first control electrode of the first transistor and the second voltage line which receives a second driving voltage. The one pixel may include a sixth transistor electrically connected between the second control electrode of the first transistor and the first initialization line which receives a first initialization voltage. Each of the control electrode of the fourth transistor and the control electrode of the sixth transistor may be electrically connected to the light emitting line which receives a light emitting signal. The control electrode of the fifth transistor may be electrically connected to an initialization scan line which receives an initialization scan signal.

In an embodiment, the electronic device may provide a scan signal including a scan section to the second transistor and the third transistor through the scan line within one frame. The electronic device may provide a data signal including a data section to the third transistor through the data line within one frame. The electronic device may provide a light emitting signal including a light emitting section to the fourth transistor and the sixth transistor through the light emitting line within one frame. The electronic device may provide an initialization scan signal including an initialization section to the fifth transistor through an initialization scan line within one frame. The data section and the scan section may overlap each other. The initialization section may precede the scan section and the data section. The light emitting section may not overlap the initialization section, the scan section and the data section.

In an embodiment, the control electrode of the fourth transistor may include a first control electrode and a second control electrode. The first control electrode and the second control electrode of the fourth transistor may be electrically connected to the light emitting line.

In an embodiment, one pixel may include a seventh transistor electrically connected between the anode of a light emitting diode and a second voltage line. The control electrode of the seventh transistor may be electrically connected to an initialization scan line.

In an embodiment, the one pixel may include a capacitor electrically connected between the first control electrode and the second control electrode of the first transistor. The one pixel may include a fourth transistor electrically connected between the anode of the light emitting diode and the second electrode of the first transistor. The one pixel may include a fifth transistor electrically connected between the first control electrode of the first transistor and the second initialization line which receives a second initialization voltage. The one pixel may include a sixth transistor electrically connected between the second control electrode of the first transistor and the first initialization line which receives a first initialization voltage. The one pixel may include an eighth transistor electrically connected between the second control electrode of the first transistor and the second initialization line. Each of the control electrode of the fourth transistor and the control electrode of the sixth transistor may be electrically connected to the light emitting line which receives a light emitting signal. Each of the control electrode of the fifth transistor and the control electrode of the eighth transistor may be electrically connected to the initialization scan line which receives an initialization signal.

To deal with the technological objective, in an embodiment, a method of operating an electronic device may include displaying an image through a display including a plurality of pixels. One of the plurality of pixels may include a light emitting diode. One pixel may include a first transistor with a first electrode electrically connected to a first voltage line which provides a first driving voltage and a second electrode electrically connected to anode of the light emitting diode. The one pixel may include a second transistor electrically connected between a first control electrode of the first transistor and a second electrode of the first transistor. The one pixel may include a third transistor electrically connected between the second control electrode of the first transistor and a data line which provides a data signal. A control electrode of the second transistor and a control electrode of the third transistor may be electrically connected to a scan line which provides a same scan signal.

In an embodiment, the displaying of the image within one frame may include providing a scan signal including a scan section to the second transistor and the third transistor through the scan line within one frame. The displaying of the image may include providing a data signal including a data section to the third transistor through the data line. The data section and the scan section may overlap each other.

In an embodiment, one pixel may include a capacitor electrically connected between a first voltage line and the first control electrode of the first transistor. The one pixel may include a fourth transistor electrically connected between the anode of the light emitting diode and the second electrode of the first transistor, and which has a control electrode electrically connected to a light emitting line which receives a light emitting signal. The displaying of the image may include providing a light emitting signal including a light emitting section to the fourth transistor through the light emitting line within one frame. The light emitting section may not overlap the scan section and the data section.

In an embodiment, the one pixel may include a fifth transistor electrically connected between a first control electrode of the first transistor and a second voltage line which receives a second driving voltage, and which has a control electrode electrically connected to an initialization scan line which receives an initialization scan signal. The displaying of the image may include providing the initialization scan signal including an initialization section to the fifth transistor through an initialization scan line within one frame. The initialization section may precede the scan section.

In an embodiment, the one pixel may include a sixth transistor electrically connected between a second control electrode of the first transistor and a first initialization line which receives a first initialization voltage, and which has a control electrode electrically connected to a light emitting line which receives a light emitting signal. The displaying of the image may include providing a light emitting signal including a light emitting section to the sixth transistor through the light emitting line within one frame. The light emitting section may not overlap the scan section and the data section.

In an embodiment, one pixel may include a capacitor electrically connected between a first voltage line and the first control electrode of the first transistor. The one pixel may include a fourth transistor electrically connected between the anode of the light emitting diode and the second electrode of the first transistor, and which has a control electrode electrically connected to a light emitting line which receives a light emitting signal. The one pixel may include a fifth transistor electrically connected between a first control electrode of the first transistor and a second voltage line which receives a second driving voltage, and which has a control electrode electrically connected to an initialization scan line which receives an initialization scan signal. The one pixel may include a sixth transistor electrically connected between the second control electrode of the first transistor and the first initialization line which receives a first initialization voltage, and which has a control electrode electrically connected to the light emitting line. The displaying of the image may include providing a scan signal including a scan section to the second transistor and the third transistor through the scan line within one frame. The displaying of the image may include providing a data signal including a data section to the third transistor through the data line. The displaying of the image may include providing a light emitting signal including a light emitting section to the fourth transistor and the sixth transistor through the light emitting line. The displaying of the image may include providing the initialization scan signal including an initialization section to the fifth transistor through an initialization scan line. The data section and the scan section may overlap each other. The initialization section may precede the scan section and the data section. The light emitting section may not overlap the initialization section, the scan section and the data section.

To deal with the technological object, a computer-readable recording medium having a program recorded thereon, when executed by a computer, to perform at least one method of the embodiments of the operating method of the electronic device described above.

The program executed by the electronic device as described above according to various embodiments may be implemented in hardware, software, and/or a combination thereof. The program may be performed by any system capable of performing computer-readable instructions.

The software may include a computer program, codes, instructions, or one or more combinations of them, and may configure a processing device to operate as desired or instruct the processing device independently or collectively.

The software may be implemented with a computer program including instructions stored in a computer-readable recording (or storage) medium. Examples of the computer-readable recording medium include a magnetic storage medium (e.g., a read only memory (ROM), a floppy disk, a hard disk, etc.), and an optical recording medium (e.g., a compact disc ROM (CD-ROM), or a digital versatile disc (DVD)). The computer-readable recording medium may also be distributed to computer systems connected over network so that the computer-readable code is stored and executed in a distributed fashion. The recording media may be read by the computer, stored in the memory, and executed by the processor.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

Furthermore, the program according to the embodiments of the disclosure may be provided in a computer program product. The computer program product may be a commercial product that may be traded between a seller and a buyer.

The computer program product may include a software program and a computer-readable storage medium having the software program stored thereon. For example, the computer program product may include a product (e.g., a downloadable application) in the form of a software program that is electronically distributed by the manufacturer of the electronic device or by an electronic market (e.g., Samsung Galaxy store®). For the electronic distribution, at least a portion of the software program may be stored in a storage medium or arbitrarily created. In this case, the storage medium may be one of a server of the manufacturer of the electronic device or of a relay server that temporarily stores the software program.

The above described embodiments may be implemented as in the following clauses.
Clause 1:

An electronic device comprising:
a display including a plurality of pixels;
a memory storing a program or at least one instruction; and
at least one processor,
wherein the at least one processor is configured to individually or collectively execute the program or the at least one instruction stored in the memory to cause the electronic device to control the display to display an image,
wherein one of the plurality of pixels comprises:
a light emitting diode;
a first transistor with a first electrode electrically connected to a first voltage line that provides a first driving voltage and a second electrode electrically connected to an anode of the light emitting diode;
a second transistor electrically connected between a first control electrode of the first transistor and the second electrode of the first transistor; and
a third transistor electrically connected between a second control electrode of the first transistor and a data line that provides a data signal, and
wherein a control electrode of the second transistor and a control electrode of the third transistor are electrically connected to a scan line that provides a same scan signal.
Clause 2:

The electronic device of clause 1, wherein:
the electronic device is configured to
provide the scan signal including a scan section to the second transistor and the third transistor through the scan line within one frame, and
provide the data signal including a data section to the third transistor through the data line, and
the data section and the scan section overlap each other.
Clause 3:

The electronic device of clause 2, wherein the one pixel further comprises:
a capacitor electrically connected between the first voltage line and the first control electrode of the first transistor; and
a fourth transistor electrically connected between the anode of the light emitting diode and the second electrode of the first transistor, and
a control electrode of the fourth transistor is electrically connected to a light emitting line that receives a light emitting signal.
Clause 4:

The electronic device of clause 3, wherein:
the electronic device is configured to provide the light emitting signal including a light emitting section to the fourth transistor through the light emitting line within one frame, and
the light emitting section does not overlap the scan section or the data section.
Clause 5:

The electronic device of any one of clauses 2 to 4, wherein:
the one pixel further comprises a fifth transistor electrically connected between the first control electrode of the first transistor and a second voltage line that receives a second driving voltage, and
the control electrode of the fifth transistor is electrically connected to an initialization scan line that receives an initialization scan signal.
Clause 6:

The electronic device of clause 5, wherein:
the electronic device is configured to provide the initialization scan signal including the initialization section to the fifth transistor through the initialization scan line within one frame, and
the initialization section precedes the scan section.
Clause 7:

The electronic device of any one of clauses 2 to 6, wherein the one pixel further comprises a sixth transistor electrically connected between the second control electrode of the first transistor and a first initialization line that receives a first initialization voltage, and
a control electrode of the sixth transistor is electrically connected to a light emitting line that receives a light emitting signal.
Clause 8:

The electronic device of clause 7, wherein the electronic device is configured to provide the light emitting signal including a light emitting section to the sixth transistor through the light emitting line within one frame, and
the light emitting section does not overlap the scan section or the data section.
Clause 9:

The electronic device of any one of clauses 1 to 8, wherein the one pixel further comprises:
a capacitor electrically connected between the first voltage line and the first control electrode of the first transistor;
a fourth transistor electrically connected between the anode of the light emitting diode and the second electrode of the first transistor;
a fifth transistor electrically connected between the first control electrode of the first transistor and a second voltage line that receives a second driving voltage; and
a sixth transistor electrically connected between the second control electrode of the first transistor and a first initialization line that receives a first initialization voltage, and
each of a control electrode of the fourth transistor and a control electrode of the sixth transistor is electrically connected to a light emitting line that receives a light emitting signal, and
the control electrode of the fifth transistor is electrically connected to an initialization scan line that receives an initialization scan signal.
Clause 10:

The electronic device of clause 9, wherein the electronic device is configured to, within one frame,
provide the scan signal including a scan section to the second transistor and the third transistor through the scan line,
provide the data signal including a data section to the third transistor through the data line, and
provide the light emitting signal including a light emitting section to the fourth transistor and the sixth transistor through the light emitting line, and
provide the initialization scan signal including an initialization section to the fifth transistor through the initialization scan line,
the data section and the scan section overlap each other,
the initialization section precedes the scan section and the data section, and
the light emitting section does not overlap the initialization section, the scan section and the data section.
Clause 11:

The electronic device of clause 9, wherein the control electrode of the fourth transistor comprises a first control electrode and a second control electrode, and
the first control electrode and the second control electrode of the fourth transistor are each electrically connected to the light emitting line.
Clause 12:

The electronic device of any one of clauses 9 to 11, wherein:
the one pixel further comprises a seventh transistor electrically connected between the anode of the light emitting diode and the second voltage line, and
a control electrode of the seventh transistor is electrically connected to the initialization scan line.
Clause 13:

The electronic device of any one of clauses 1 to 12, wherein:
the one pixel further comprises
a capacitor electrically connected between the first control electrode and the second control electrode of the first transistor;
a fourth transistor electrically connected between the anode of the light emitting diode and the second electrode of the first transistor;
a fifth transistor electrically connected between the first control electrode of the first transistor and a second initialization line that receives a second initialization voltage;
a sixth transistor electrically connected between the second control electrode of the first transistor and a first initialization line that receives a first initialization voltage; and
an eighth transistor electrically connected between the second control electrode of the first transistor and the second initialization line, and
each of a control electrode of the fourth transistor and a control electrode of the sixth transistor is electrically connected to a light emitting line that receives a light emitting signal, and
each of a control electrode of the fifth transistor and a control electrode of the eighth transistor is electrically connected to an initialization scan line that receives an initialization signal.
Clause 14:

A method of operating an electronic device, the method comprising:
displaying an image through a display including a plurality of pixels,
wherein one of the plurality of pixels comprises:
a light emitting diode;
a first transistor with a first electrode electrically connected to a first voltage line that provides a first driving voltage and a second electrode electrically connected to an anode of the light emitting diode;
a second transistor electrically connected between a first control electrode of the first transistor and the second electrode of the first transistor; and
a third transistor electrically connected between a second control electrode of the first transistor and a data line that provides a data signal, and
wherein a control electrode of the second transistor and a control electrode of the third transistor are electrically connected to a scan line that provides a same scan signal.
Clause 15:

The method of clause 14, wherein the displaying of the image comprises:
providing the scan signal including a scan section to the second transistor and the third transistor through the scan line within one frame; and
providing the data signal including a data section to the third transistor through the data line,
the data section and the scan section overlap each other.
Clause 16:

The method of clause 15, wherein:
the one pixel further comprises
a capacitor electrically connected between the first voltage line and the first control electrode of the first transistor; and
a fourth transistor electrically connected between the anode of the light emitting diode and the second electrode of the first transistor, and having a control electrode electrically connected to a light emitting line that receives a light emitting signal,
the displaying of the image further comprises
providing the light emitting signal including a light emitting section to the fourth transistor through the light emitting line within one frame, and
the light emitting section does not overlap the scan section or the data section.
Clause 17:

The method of any one of clauses 15 or 16, wherein:
the one pixel further comprises a fifth transistor electrically connected between a first control electrode of the first transistor and a second voltage line that receives a second driving voltage, and having a control electrode electrically connected to an initialization scan line that receives an initialization scan signal,
the displaying of the image comprises providing the initialization scan signal including an initialization section to the fifth transistor through the initialization scan line within one frame, and
the initialization section precedes the scan section.
Clause 18:

The method of any one of clauses 15 to 17, wherein:
the one pixel further comprises a sixth transistor electrically connected between a second control electrode of the first transistor and a first initialization line that receives a first initialization voltage, and having a control electrode electrically connected to a light emitting line that receives a light emitting signal,
the displaying of the image comprises providing the light emitting signal including a light emitting section to the sixth transistor through the light emitting line within one frame, and
the light emitting section does not overlap the scan section or the data section.
Clause 19:

The method of any one of clauses 14 to 18, wherein:
the one pixel further comprises
a capacitor electrically connected between the first voltage line and the first control electrode of the first transistor;
a fourth transistor electrically connected between the anode of the light emitting diode and the second electrode of the first transistor, and having a control electrode electrically connected to a light emitting line that receives a light emitting signal;
a fifth transistor electrically connected between a first control electrode of the first transistor and a second voltage line that receives a second driving voltage, and having a control electrode electrically connected to an initialization scan line that receives an initialization scan signal; and
a sixth transistor electrically connected between a second control electrode of the first transistor and a first initialization line that receives a first initialization voltage, and having a control electrode electrically connected to the light emitting line,
the displaying of the image comprises
providing the scan signal including a scan section to the second transistor and the third transistor through the scan line within one frame;
providing the data signal including a data section to the third transistor through the data line;
providing the light emitting signal including a light emitting section to the fourth transistor and the sixth transistor through the light emitting line; and
providing the initialization scan signal including an initialization section to the fifth transistor through the initialization scan line,
the data section and the scan section overlap each other,
the initialization section precedes the scan section and the data section, and
the light emitting section does not overlap the initialization section, the scan section and the data section.
Clause 20:

A computer-readable recording medium having recorded thereon a program for, when executed by a computer, carrying out the method of any one of clauses 14 to 19.

Although the disclosure is described with reference to some embodiments as described above and accompanying drawings, it will be apparent to those of ordinary skill in the art that various modifications and changes can be made to the embodiments. For example, the aforementioned method may be performed in a different order, and/or the aforementioned components such as a computer system or a module may be combined in a different form from what is described above, and/or replaced or substituted by other components or equivalents thereof, to obtain appropriate results. These modifications should also be understood to fall within the scope and spirit of the disclosure and accompanying claims.

What is claimed is:

1. An electronic device comprising:
a display including a plurality of pixels;
a memory storing a program or at least one instruction; and
at least one processor,
wherein the at least one processor is configured to individually or collectively execute the program or the at least one instruction stored in the memory to cause the electronic device to:
control the display to display an image,
wherein one pixel of the plurality of pixels comprises:
a light emitting diode;
a first transistor having a first electrode, a first control electrode, a second control electrode, and a second electrode, the first electrode being electrically connected to a first voltage line that provides a first driving voltage and the second electrode being electrically connected to an anode of the light emitting diode;
a second transistor having a control electrode, the second transistor being electrically connected between the first control electrode of the first transistor and the second electrode of the first transistor; and
a third transistor having a control electrode, the third transistor being electrically connected between the second control electrode of the first transistor and a data line that provides a data signal, and
wherein the control electrode of the second transistor and the control electrode of the third transistor are electrically connected to a scan line that provides a same scan signal.

2. The electronic device of claim 1, wherein:
the electronic device is configured to:
provide the scan signal including a scan section to the second transistor and the third transistor through the scan line within one frame, and
provide the data signal including a data section to the third transistor through the data line, and
the data section and the scan section overlap each other.

3. The electronic device of claim 2, wherein the one pixel further comprises:
a capacitor electrically connected between the first voltage line and the first control electrode of the first transistor; and
a fourth transistor having a control electrode, the fourth transistor being electrically connected between the anode of the light emitting diode and the second electrode of the first transistor, and
wherein the control electrode of the fourth transistor is electrically connected to a light emitting line that receives a light emitting signal.

4. The electronic device of claim 3, wherein:
the electronic device is configured to provide the light emitting signal including a light emitting section to the fourth transistor through the light emitting line within the one frame, and
the light emitting section does not overlap the scan section or the data section.

5. The electronic device of claim 2, wherein:
the one pixel further comprises a fifth transistor having a control electrode, the fifth transistor being electrically connected between the first control electrode of the first transistor and a second voltage line that receives a second driving voltage, and
the control electrode of the fifth transistor is electrically connected to an initialization scan line that receives an initialization scan signal.

6. The electronic device of claim 5, wherein:
the electronic device is configured to provide the initialization scan signal including the initialization section to the fifth transistor through the initialization scan line within the one frame, and
the initialization section precedes the scan section.

7. The electronic device of claim 2, wherein the one pixel further comprises a sixth transistor having a control electrode, the sixth transistor being electrically connected between the second control electrode of the first transistor and a first initialization line that receives a first initialization voltage, and
wherein the control electrode of the sixth transistor is electrically connected to a light emitting line that receives a light emitting signal.

8. The electronic device of claim 7, wherein the electronic device is configured to provide the light emitting signal including a light emitting section to the sixth transistor through the light emitting line within the one frame, and
the light emitting section does not overlap the scan section or the data section.

9. The electronic device of claim 1, wherein the one pixel further comprises:
a capacitor electrically connected between the first voltage line and the first control electrode of the first transistor;
a fourth transistor having a control electrode, the fourth transistor being electrically connected between the anode of the light emitting diode and the second electrode of the first transistor;
a fifth transistor having a control electrode, the fifth transistor being electrically connected between the first control electrode of the first transistor and a second voltage line that receives a second driving voltage; and
a sixth transistor having a control electrode, the sixth transistor being electrically connected between the second control electrode of the first transistor and a first initialization line that receives a first initialization voltage, and
each of a control electrode of the fourth transistor and a control electrode of the sixth transistor is electrically connected to a light emitting line that receives a light emitting signal, and
wherein the control electrode of the fifth transistor is electrically connected to an initialization scan line that receives an initialization scan signal.

10. The electronic device of claim 9, wherein the electronic device is configured to, within the one frame,
provide the scan signal including a scan section to the second transistor and the third transistor through the scan line,
provide the data signal including a data section to the third transistor through the data line, and
provide the light emitting signal including a light emitting section to the fourth transistor and the sixth transistor through the light emitting line, and
provide the initialization scan signal including an initialization section to the fifth transistor through the initialization scan line,
the data section and the scan section overlap each other,
the initialization section precedes the scan section and the data section, and
the light emitting section does not overlap the initialization section, the scan section and the data section.

11. The electronic device of claim 9, wherein the control electrode of the fourth transistor comprises a first control electrode and a second control electrode, and
the first control electrode and the second control electrode of the fourth transistor are each electrically connected to the light emitting line.

12. The electronic device of claim 9, wherein:
the one pixel further comprises a seventh transistor having a control electrode, the seventh transistor being electrically connected between the anode of the light emitting diode and the second voltage line, and
wherein the control electrode of the seventh transistor is electrically connected to the initialization scan line.

13. The electronic device of claim 1, wherein:
the one pixel further comprises:
a capacitor electrically connected between the first control electrode and the second control electrode of the first transistor;
a fourth transistor electrically having a control electrode, the fourth transistor being connected between the anode of the light emitting diode and the second electrode of the first transistor;
a fifth transistor having a control electrode, the fifth transistor being electrically connected between the first control electrode of the first transistor and a second initialization line that receives a second initialization voltage;
a sixth transistor having a control electrode, the sixth transistor being electrically connected between the second control electrode of the first transistor and a first initialization line that receives a first initialization voltage; and
an eighth transistor having a control electrode, the eighth transistor being electrically connected between the second control electrode of the first transistor and the second initialization line, and
each of the control electrode of the fourth transistor and the control electrode of the sixth transistor is electrically connected to a light emitting line that receives a light emitting signal, and
each of the control electrode of the fifth transistor and the control electrode of the eighth transistor is electrically connected to an initialization scan line that receives an initialization signal.

14. A method of operating an electronic device, the method comprising:
displaying an image through a display including a plurality of pixels,
wherein one pixel of the plurality of pixels comprises:
a light emitting diode;
a first transistor having a first electrode, a first control electrode, a second control electrode, and a second electrode, the first transistor being electrically connected to a first voltage line that provides a first driving voltage and a second electrode electrically connected to an anode of the light emitting diode;
a second transistor having a control electrode, the second transistor being electrically connected between the first control electrode of the first transistor and the second electrode of the first transistor; and
a third transistor having a control electrode, the third transistor being electrically connected between the second control electrode of the first transistor and a data line that provides a data signal, and
wherein the control electrode of the second transistor and the control electrode of the third transistor are electrically connected to a scan line that provides a same scan signal.

15. The method of claim 14, wherein the displaying of the image comprises:
providing the scan signal including a scan section to the second transistor and the third transistor through the scan line within one frame; and
providing the data signal including a data section to the third transistor through the data line,
the data section and the scan section overlap each other.

16. The method of claim 15, wherein:
the one pixel further comprises
a capacitor electrically connected between the first voltage line and the first control electrode of the first transistor; and
a fourth transistor electrically connected between the anode of the light emitting diode and the second electrode of the first transistor, and having a control electrode electrically connected to a light emitting line that receives a light emitting signal,
the displaying of the image further comprises
providing the light emitting signal including a light emitting section to the fourth transistor through the light emitting line within the one frame, and
the light emitting section does not overlap the scan section or the data section.

17. The method of claim 15, wherein:
the one pixel further comprises a fifth transistor electrically connected between the first control electrode of the first transistor and a second voltage line that receives a second driving voltage, and having a control electrode electrically connected to an initialization scan line that receives an initialization scan signal,
the displaying of the image comprises providing the initialization scan signal including an initialization section to the fifth transistor through the initialization scan line within the one frame, and
the initialization section precedes the scan section.

18. The method of claim 15, wherein:
the one pixel further comprises a sixth transistor electrically connected between the second control electrode of the first transistor and a first initialization line that receives a first initialization voltage, and having a control electrode electrically connected to a light emitting line that receives a light emitting signal,
the displaying of the image comprises providing the light emitting signal including a light emitting section to the sixth transistor through the light emitting line within the one frame, and
the light emitting section does not overlap the scan section or the data section.

19. The method of claim 14, wherein:
the one pixel further comprises
a capacitor electrically connected between the first voltage line and the first control electrode of the first transistor;
a fourth transistor electrically connected between the anode of the light emitting diode and the second electrode of the first transistor, and having a control electrode electrically connected to a light emitting line that receives a light emitting signal;
a fifth transistor electrically connected between the first control electrode of the first transistor and a second voltage line that receives a second driving voltage, and having a control electrode electrically connected to an initialization scan line that receives an initialization scan signal; and
a sixth transistor electrically connected between the second control electrode of the first transistor and a first initialization line that receives a first initialization voltage, and having a control electrode electrically connected to the light emitting line,
the displaying of the image comprises:
providing the scan signal including a scan section to the second transistor and the third transistor through the scan line within the one frame;
providing the data signal including a data section to the third transistor through the data line;
providing the light emitting signal including a light emitting section to the fourth transistor and the sixth transistor through the light emitting line; and
providing the initialization scan signal including an initialization section to the fifth transistor through the initialization scan line,
the data section and the scan section overlap each other,
the initialization section precedes the scan section and the data section, and
the light emitting section does not overlap the initialization section, the scan section and the data section.

20. A non-transitory computer-readable recording medium having recorded thereon a program which, when executed by a computer, causes the computer to display an image through a display including a plurality of pixels,
wherein one pixel of the plurality of pixels comprises:
a light emitting diode;
a first transistor having a first electrode, a first control electrode, a second control electrode, and a second electrode, the first transistor being electrically connected to a first voltage line that provides a first driving voltage and a second electrode electrically connected to an anode of the light emitting diode;
a second transistor having a control electrode, the second transistor being electrically connected between the first control electrode of the first transistor and the second electrode of the first transistor; and
a third transistor having a control electrode, the third transistor being electrically connected between the second control electrode of the first transistor and a data line that provides a data signal, and
wherein the control electrode of the second transistor and the control electrode of the third transistor are electrically connected to a scan line that provides a same scan signal.
